(19) United States
(12) Patent Application Publication
(10) Pub. No.: US 2025/0212074 A1
(43) Pub. Date: Jun. 26, 2025

(54) ROAMING PROCEDURE FOR CONTEXT TRANSFER DURING ROAMING IN A MULTI-LINK OPERATION NETWORK

(71) Applicant: Cisco Technology, Inc., San Jose, CA (US)

(72) Inventors: Binita Gupta, San Diego, CA (US); Brian Donald Hart, Sunnyvale, CA (US); Malcolm Muir Smith, Richardson, TX (US)

(21) Appl. No.: 18/989,862

(22) Filed: Dec. 20, 2024

Related U.S. Application Data
(60) Provisional application No. 63/612,515, filed on Dec. 20, 2023.
(60) Provisional application No. 63/620,876, filed on Jan. 14, 2024.
(60) Provisional application No. 63/719,044, filed on Nov. 11, 2024.

(51) Int. Cl. H04W 36/08; H04W 36/00; H04W 36/18; H04W 88/10

(52) U.S. Cl. CPC H04W 36/08; H04W 36/0033; H04W 36/18; H04W 88/10

(57) ABSTRACT

In one aspect, a method includes initiating a roaming procedure for a Non-Access Point Multi-Link Device (Non-AP MLD) to roam from a current Access Point Multi-Link Device (AP MLD) onto a target AP MLD; determining whether a multi-phased roaming procedure for the Non-AP MLD to roam to the target AP MLD is possible; performing the multi-phased roaming procedure when the multi-phased roaming procedure is possible; and performing a single-phased roaming procedure when the multi-phased roaming procedure is not possible.

### CROSS-REFERENCE TO RELATED APPLICATIONS

This application claims priority to and the benefit of U.S. Prov. App. No. 63/612,515, filed on Dec. 20, 2023, U.S. Prov. App. No. 63/620,876, filed on Jan. 14, 2024, and U.S. Prov. App. No. 63/719,044, filed on Nov. 11, 2024, the content of each of which is incorporated herein by reference in their entirety.

### TECHNICAL FIELD

The present technology pertains to wireless communication network, and more specifically, to signaling procedures for enabling context transfer when a device roams from one access point to another in a Multi-Link Operation wireless network.

### BACKGROUND

Wi-Fi technology has undergone continuous evolution and innovation since its inception, resulting in significant advancements with each new generation. Following Wi-Fi 5 (802.11ac) there has been Wi-Fi 6 (802.11ax), Wi-Fi 7 (802.11be), and soon there will be Wi-Fi 8 (802.11bn) and Wi-Fi 9, each new Wi-Fi generation brings notable improvements in speed, capacity, efficiency, and overall performance.

Wi-Fi 5 introduced substantial upgrades over its predecessor, Wi-Fi 4 (802.11n). It introduced the use of wider channel bandwidths, multi-user Multiple-Input Multiple-Output (MIMO), and beamforming technologies. These advancements significantly increased data transfer rates and improved network capacity, allowing multiple devices to simultaneously connect and communicate more efficiently. Wi-Fi 6/6E included enhanced orthogonal frequency-division multiple access (OFDMA) and target wake time (TWT) mechanisms and included greater frequency and improved overall spectral efficiency and power management and better performance in crowded areas. Wi-Fi 7 (802.11be) delivers speeds of up to 30 Gbps, utilizing multi-band operation, wider bandwidth, advanced MIMO techniques, and improved modulation schemes. Wi-Fi 7 also focuses on reducing latency and enhancing security features.

Wi-Fi 8 (802.11bn) aims to revolutionize wireless connectivity by providing ultra-high reliability enabling rich experiences for QoS demanding applications such as cloud gaming, AR/VR, industrial IoT, wireless TSN etc. Wi-Fi 8 is expected to introduce advancements like seamless roaming, multi-AP coordination for predictable QoS, enhanced power saving and advanced beamforming techniques paving the way for futuristic applications and seamless connectivity experiences.

As Wi-Fi technology continues to evolve, each new Wi-Fi generation brings improvements that address the growing demands of modern networks, including increased device density, higher data rates, lower latency, improved reliability and better overall network performance. These advancements play a crucial role in enabling emerging technologies, supporting the proliferation of smart devices, and transforming the way we connect and communicate in an increasingly interconnected world.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a block diagram of an example wireless communication network according to some aspects of the present disclosure.

FIG. 2A illustrates an example of a single floor of building equipped with wireless communication according to some aspects of the present disclosure.

FIG. 2B depicts an illustrative schematic diagram for MLO between an AP MLD with affiliated logical entities and a Non-AP MLD with affiliated logical entities according to some aspects of the present disclosure.

FIG. 3 illustrates an example of a seamless mobility domain according to some aspect of the present disclosure.

FIG. 4 illustrates an example method of roaming execution in an MLO wireless network according to some aspects of the present disclosure.

FIG. 5 illustrates an example process of a client initiated multi-phased roaming procedure according to some aspects of the present disclosure.

FIG. 6 illustrates an example of a signaling exchange between a Non-AP MLD and a current AP MLD for performing switch link operation according to some aspects of the present disclosure.

FIG. 7 illustrates an example process of an AP MLD initiated multi-phased roaming procedure according to some aspects of the present disclosure.

FIG. 8 illustrates an example of a signaling exchange between a Non-AP MLD and a current AP MLD for performing switch link operation according to some aspects of the present disclosure.

FIG. 9 shows an example of a computing system according to some aspects of the present disclosure.

### DETAILED DESCRIPTION

Various embodiments of the disclosure are discussed in detail below. While specific implementations are discussed, it should be understood that this is done for illustration purposes only. A person skilled in the relevant art will recognize that other components and configuration s may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

A used herein the term “configured” shall be considered to interchangeably be used to refer to configured and configurable, unless the term “configurable” is explicitly used to distinguish from “configured”. The proper understanding of the term will be apparent to persons of ordinary skill in the art in the context in which the term is used.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

### Abbreviations

Access Point (AP)
Advanced Encryption Standard (AES)
Association and key management (AKM)
Basic service set (BSS)
Extended Service Set (ESS)
Extremely high throughput (EHT)
Fast Transition (FT)
Mobile Device Management (MDM)
Multi-Link Device (MLD)
Multi-link Operation (MLO)
Network Interface Device (NID)
Pairwise Master Key (PMK)
Pairwise Transient Key (PTK)
Robust Security Network Element (RSNE)
Seamless Mobility Domain (SMD)
Service Set Identifier (SSID)
Station (STA)
Wi-Fi Protected Access (WPA)
Wireless Local Area Network (WLAN)
Wireless LAN Controller (WLC)

Mobility Domain MLD (MDM), also Seamless Mobility Domain (SMD) refer to a logical entity including multiple AP MLDs to which a STA (a Wi-Fi client device or Non-AP MLD) associates.

As used herein, the term “configured” shall be considered to be used interchangeably with configured and configurable, unless the term “configurable” is explicitly used to distinguish from “configured.” The proper understanding of the term will be apparent to persons of ordinary skill in the art in the context in which the term is used.

Aspects of the present disclosure can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IoT) network.

IEEE 802.11, commonly referred to as Wi-Fi, has been around for three decades and has become arguably one of the most popular wireless communication standards, with billions of devices supporting more than half of the worldwide wireless traffic. The increasing user demands in terms of throughput, capacity, latency, spectrum, and power efficiency calls for updates or amendments to the standard to keep up with them. As such, Wi-Fi generally has a new amendment after every few years with its own characteristic features. In the earlier generations, the focus was primarily higher data rates, but with ever increasing density of devices, area efficiency has become a major concern for Wi-Fi networks. Due to this issue, the last (802.11 be (Wi-Fi 7)) amendments focused more on efficiency though higher data rates were also included. The next expected update to IEEE 802.11 is coined as Wi-Fi 8. Wi-Fi 8 will attempt to further enhance throughput and minimize latency to meet the ever-growing demand for the Internet of Things (IoT), high resolution video streaming, low-latency wireless services, etc.

Multiple Access Point (AP) coordination and transmission in Wi-Fi refers to the management of multiple access points in a wireless network to avoid interference and ensure efficient communication between the STA devices and the network. When multiple access points are deployed in a network—for instance in buildings and office complexes—they operate on the same radio frequency, which can cause interference and degrade the network performance. To mitigate this issue, access points can be configured to coordinate their transmissions and avoid overlapping channels.

Wi-Fi 7 introduced the concept of multi-link operation (MLO), which gives the devices (Access Points (APs) and Stations (STAs)) the capability to operate on multiple links (or even bands) at the same time. MLO introduces a new paradigm to multi-AP coordination which was not part of the earlier coordination approaches. MLO is considered in Wi-Fi-7 to improve the throughput of the network and address the latency issues by allowing devices to use multiple links.

A multi-link device (MLD) may have several “affiliated” devices, each affiliated device having a separate PHY interface, and the MLD having a single link to the Logical Link Control (LLC) layer. In IEEE 802.11be, a multi-link device (MLD) is defined as: “A device that is a logical entity and has more than one affiliated station (STA) and has a single medium access control (MAC) service access point (SAP) to logical link control (LLC), which includes one MAC data service” (see: LAN/MAN Standards Committee of the IEEE Computer Society, Amendment 8: Enhancements for extremely high throughput (EHT), IEEE P802.11 beTM/D0.1, September 2020, section 3.2). Connection(s) with an MLD on the affiliated devices may occur independently or jointly. A preliminary definition and scope of a multi-link element is described in section 9.4.2.247b of aforementioned IEEE 802.11 be draft. An idea behind this information element/container is to provide a way for multi-link devices (MLDs) to share the capabilities of different links with each other and facilitate the discovery and association processes. However, this information element may still be changed, or new mechanisms may be introduced to share the MLO information (e.g., related to backhaul usage).

In multi-link operation (MLO) both STA and APs can possess multiple links that can be simultaneously active. These links may or may not use the same bands/channels.

MLO allows sending PHY protocol data units (PPDUs) on more than one link between a STA and an AP. The links may be carried on different channels, which may be in different frequency bands. Based on the frequency band and/or channel separation and filter performance, there may be restrictions on the way the PPDUs are sent on each of the links.

MLO may include a basic transmission mode, an asynchronous transmission mode, and a synchronous transmission mode.

In a basic transmission mode, there may be multiple primary links, but a device may transmit PPDU on one link at a time. The link for transmission may be selected as follows. The device (such as an AP or a STA) may count down a random back off (RBO) on both links and select a link that wins the medium for transmission. The other link may be blocked by in-device interference. In basic transmission mode, aggregation gains may not be achieved.

In an asynchronous transmission mode, a device may count down the RBO on both links and perform PPDU transmission independently on each link. The asynchronous transmission mode may be used when the device can support simultaneous transmission and reception with bands that have sufficient frequency separation such as separation between the 2.4 GHz band and the 5 GHz band. The asynchronous transmission mode may provide both latency and aggregation gains.

In a synchronous PPDU transmission mode, the device may count down the RBO on both links. If a first link wins the medium, both links may transmit PPDUs at the same time. The transmission at the same time may minimize in-device interference and may provide both latency and aggregation gains.

Multi-AP coordination and MLO are two features directed to improve the performance of Wi-Fi networks as the Multi-AP coordination is directed toward utilizing (distributed) coordination between different APs to reduce inter-Basic Service Set (BSS) interference for improved spectrum utilization in dense deployments, and the MLO supports high data rates and low latency by leveraging flexible resource utilization offered by the use of multiple links for the same device.

### Overview

The present disclosure is directed to phased roaming procedure in which different context associated with performance of a Non-AP MLD in a Wi-Fi network are transferred from a current AP MLD to a target AP MLD in a manner that minimizes adverse impact on data transfer and operation of the Non-AP MLD in the network during the execution of the roaming process.

In one aspect, a method includes initiating a roaming procedure for a Non-Access Point Multi-Link Device (Non-AP MLD) to roam from a current Access Point Multi-Link Device (current AP MLD) onto a target AP MLD; determining whether a multi-phased roaming procedure for the Non-AP MLD to roam to the target AP MLD is possible; performing the multi-phased roaming procedure when the multi-phased roaming procedure is possible; and performing a single-phased roaming procedure when the multi-phased roaming procedure is not possible.

In another aspect, the multi-phased roaming procedure includes a roaming preparation phase procedure and a roaming execution phase procedure.

In another aspect, the roaming preparation phase procedure includes one or more of transferring a first one or more static context associated with the Non-AP MLD to one or more candidate target AP MLDs, wherein the target AP MLD is selected from among the one or more candidate target AP MLDs; negotiating a second one or more static context associated with the Non-AP MLD with one or more candidate target AP MLDs; setting up one or more first links for the Non-AP MLD with one or more candidate target AP MLDs, and reserving one or more resources on the one or more candidate target AP MLDs for possible roaming of the Non-AP MLD thereon.

In another aspect, the one or more candidate target AP MLDs, the target AP MLD and the current AP MLD are associated with a same seamless mobility domain; and the roaming preparation phase procedure is initiated by the Non-AP MLD or the current AP MLD.

In another aspect, the first one or more static context and the second one or more static context include at least one of block acknowledgement agreements setup for the Non-AP MLD; stream classification service (SCS) streams setup for the Non-AP MLD; mirrored stream classification service (MSCS) streams setup for the Non-AP MLD; target wake time (TWT) agreements setup for the Non-AP MLD; TID-to-link mapping (TTLM) agreements setup for the Non-AP MLD, security association context associated with the Non-AP MLD, and capabilities of the Non-AP MLD.

In another aspect, the method further includes providing a roaming allowed duration (RAD) to the Non-AP MLD that indicates a window of time during for the Non-AP MLD to complete the roaming execution phase procedure.

In another aspect, the method further includes sending a roaming preparation request to the current AP MLD to initiate the roaming preparation phase procedure, and receiving a roaming preparation response from the current AP MLD after the roaming preparation phase procedure is performed.

In another aspect, the roaming preparation request is one of a link reconfiguration request frame, a link reconfiguration notify frame, or another management frame; and the roaming preparation response is one of a link reconfiguration response frame, a link reconfiguration notify frame or another management frame.

In another aspect, the roaming execution phase procedure includes one or more of transferring a first one or more dynamic context associated with the Non-AP MLD to the target AP MLD; negotiating a second one or more dynamic context associated with the Non-AP MLD with the target AP MLD; setting up one or more second links for the Non-AP MLD with the target AP MLD; and changing a distribution system mapping to switch a data path for the Non-AP MLD from the current AP MLD to the target AP MLD.

In another aspect, the first one or more dynamic context and the second one or more dynamic context include at least one of a sequence numbers (SN); a packet numbers (PN); block acknowledgement agreements, block acknowledgement parameters and related context; or duplicate receiver caches corresponding to data associated with the Non-AP MLD.

In another aspect, the method further includes sending, by the Non-AP MLD, a roaming execution request to the current AP MLD to initiate the roaming execution phase procedure and receiving a roaming execution response from the current AP MLD after the roaming execution phase procedure is performed.

In another aspect, the roaming execution request is a link reconfiguration request frame or another management frame; and the roaming execution response is a link reconfiguration response frame or another management frame.

In another aspect, the multi-phased roaming procedure for the Non-AP MLD to roam to the target AP MLD is not possible when an unexpected network performance degradation is detected for the Non-AP MLD.

In another aspect, the single-phased roaming procedure includes a roaming execution phase procedure that includes on or more of transferring at least one of one or more static context, or one or more dynamic context associated with the Non-AP MLD to the target AP MLD; negotiating at least one of the one or more static context, or the one or more dynamic context associated with the Non-AP MLD; setting up one or more links for the Non-AP MLD with the target AP MLD; and changing a distribution system mapping to switch a data path for the Non-AP MLD from the current AP MLD to the target AP MLD.

In another aspect, initiating the roaming procedure includes detecting one or more roaming factors that trigger the Non-AP MLD to initiate the roaming procedure.

In one aspect, a device includes one or more memories having computer-readable instructions stored therein; and one or more processors. The one or more processors are configured to execute the computer-readable instructions to initiate a roaming procedure for the device to roam from a current Access Point Multi-Link Device (AP MLD) onto a target AP MLD; determine whether a multi-phased roaming procedure for the device to roam to the target AP MLD is possible; perform the multi-phased roaming procedure when the multi-phased roaming procedure is possible; and perform a single-phased roaming procedure when the multi-phased roaming procedure is not possible.

In another aspect, the device is a Non-Access Point Multi-Link Device (Non-AP MLD).

In another aspect, the multi-phased roaming procedure includes a roaming preparation phase procedure and a roaming execution phase procedure.

In another aspect, the roaming preparation phase procedure includes at least one of exchanging one or more static context associated with the device to one or more candidate target AP MLDs, wherein the target AP MLD is selected from among the one or more candidate target AP MLDs; reserving one or more resources on the one or more candidate target AP MLDs for possible roaming of the device thereon.

In another aspect, the roaming execution phase procedure includes sending one or more dynamic context associated with the device to the target AP MLD.

In one aspect, one or more non-transitory computer-readable media include computer-readable instructions, which when executed by one or more processors of a Non-Access Point Multi-Link Device (Non-AP MLD), cause the Non-AP MLD to initiate a roaming procedure for the device to roam from a current Access Point Multi-Link Device (AP MLD) onto a target AP MLD; determine whether a multi-phased roaming procedure for the device to roam to the target AP MLD is possible; perform the multi-phased roaming procedure when the multi-phased roaming procedure is possible; and perform a single-phased roaming procedure when the multi-phased roaming procedure is not possible.

### Example Embodiments

In Wi-Fi 8, support for seamless or smooth roaming capability is a strong consideration to improve Wi-Fi roaming quality. In particular, to support smooth roaming or mobility in a campus wide Wi-Fi network, Wi-Fi client devices can create an association with the campus-network (also referenced herein as an ESS, an NID, and/or an MDM) instead of creating an association with an individual AP MLD. The ESS might be represented by a mobility domain or a global network (e.g., NID). Further, within a single mobility domain, there can be multiple “sub-mobility domains,” where each of the multiple “sub-mobility domains” may map to a single campus.

Currently, a Wi-Fi client device creates its association with the ESS network represented by a (sub) Mobility Domain Multi-Link Device (MLD), instead of associating with a single AP MLD within the ESS. Such an architecture can enable the Wi-Fi client device to roam seamlessly between AP MLDs without requiring re-association and reestablishment of contexts with each new AP MLD. Further, because the Wi-Fi client device associates with the Mobility Domain MLD covering all the AP MLDs of the ESS, such an architecture also reduces roaming time to realize seamless roaming.

As part of efforts to support such seamless and smooth roaming (within a given ESS or otherwise), it is desired to reduce roaming transition time and minimize delays added due to roaming operations. When roaming to a new target AP MLD, the context for a STA needs to be transferred/established on the target AP MLD. Some of this context requires reserving resources on the target AP MLD. If this context transfer needs to be established again by the STA with the target AP MLD, then doing so adds significant delay and network overhead associated with the roaming. Hence, it is desired to transfer the context between AP MLDs and reserve resources on the target AP MLD to achieve fast roaming time.

However, transferring all the context and reserving resources on target AP MLDs can add to roaming delays and impact data flow during roaming. Hence, it is desired to define an approach where data flow is impacted minimally during context transfer for roaming operation.

Aspects of the present disclosure are directed to a mechanism to minimize roaming delays added due to context transfer by using phased transfer of context/state information.

This disclosure provides various embodiments related to context transfers (and resource reservations) on target AP MLD(s) in one or more phases. In some examples, static context are transferred during a roaming preparation phase and dynamic context/state is transferred during a roaming execution phase where the data flow might be impacted. Additionally, enhancements are disclosed to provide a time-bound completion for roaming operation to avoid over reserving of resources for a long period of time on potential candidate AP MLDs for roaming.

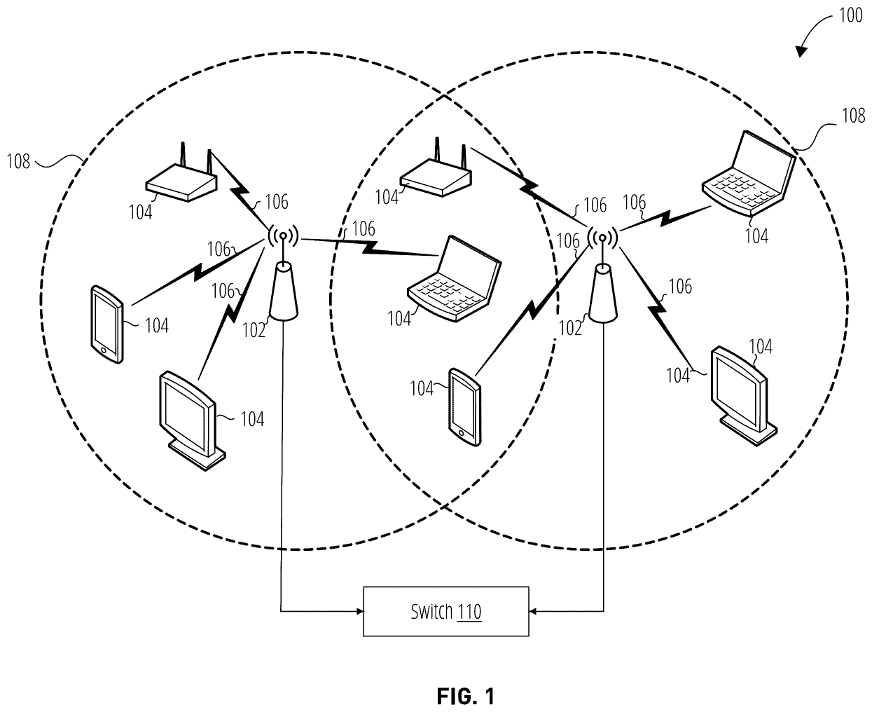

FIG. 1 illustrates a block diagram of an example wireless communication network according to some aspects of the present disclosure. According to some aspects, the wireless communication network 100 may be an example of a wireless local area network (WLAN) such as a Wi-Fi network. For example, the wireless communication network 100 may be a network implementing at least one of the IEEE 802.11 family of wireless communication protocol standards and amendments thereof (such as that defined by the IEEE 802.11-2016 specification or amendments thereof including, but not limited to, 802.11ay, 802.11ax, 802.11az, 802.11ba and 802.11be). Additionally, the wireless communication network 100 may implement future versions and amendments of the wireless communication protocol standards and amendments thereof such as 802.11bn and be modified according to the present disclosure to include the features contained herein.

Wireless communication network 100 may include numerous wireless communication devices such as an AP actor, which can be one or more of a non-MLD AP, an AP affiliated with an AP MLD, and/or an AP MLD. In the examples presented herein, the AP actor can exclude an upper UMAC. Therefore, the AP actor can include the lower UMAC, LMAC, and/or PHY. Additionally, the WLAN can include one or more of STA actors 104, which can be one or more of a non-MLD STA, a STA affiliated with a Non-AP MLD, and/or a Non-AP MLD. As illustrated, wireless communication network 100 also may include multiple AP actors such as AP actors 102 (may also be referred to as simply AP). AP actors 102 can be coupled to one another through a switch 110. While AP actors 102 are shown as being coupled to one another through switch 110, wireless communication network 100 can provide another device that allows the coupling of multiple AP actors.

Each of the STA actors 104 also may be referred to as a mobile station (MS), a mobile device, a mobile handset, a wireless handset, an access terminal (AT), a user equipment (UE), a subscriber station (SS), client, or a subscriber unit, among other examples. The STA actors 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other examples. In other examples, the STA actors 104 can be referred to as clients and/or client devices.

Any one of AP actors 102 and an associated set of STA actors (e.g., STA actors 104) may be referred to as a basic service set (BSS), which is managed by a respective AP actor of AP actors 102. FIG. 1 additionally shows an example coverage area 108 of the each of AP actors 102, which may represent a basic service area (BSA) of wireless communication network 100. As illustrated, three of STA actors 104 are within the BSA of each of AP actors 102. The BSS may be identified to users by a service set identifier (SSID), where the BSS might be one of many in the SSID. The BSS may be identified to other devices by a unique (or substantially unique) basic service set identifier (BSSID). One or more of AP actors 102 periodically broadcasts beacon frames (“beacons”) including the BSSID to enable STA actors 104 within wireless range of AP actors 102 to “associate” or re-associate with AP actors 102 to establish a respective communication link of communication links 106 (hereinafter also referred to as a “Wi-Fi link”), or to maintain communication links 106, with AP actors 102. For example, the beacons may include an identification of a primary channel used by respective AP actor of AP actors 102 as well as a timing synchronization function for establishing or maintaining timing synchronization with AP actors 102. AP actors 102 may provide communication links 106 to STA actors 104 and therefore access to external networks. While the example has been described in regard to AP actors 102 and STA actors 104, the present disclosure extends such that an AP actor may provide access to external networks to various STA actors in a WLAN via communication links 106.

To establish communication links 106 with any one of AP actors 102, each of STA actors 104 is configured to perform passive or active scanning operations (“scans”) on frequency channels in one or more frequency bands (for example, the 2.4 GHZ, 5 GHZ, 6 GHz or 60 GHz bands). To perform passive scanning, STA actors 104 listen for beacons, which are transmitted by a respective AP actor of AP actors 102 at or near a periodic time referred to as the target beacon transmission time (TBTT) (measured in time units (TUs) where one TU may be equal to 1024 microseconds (μs)). To perform active scanning, STA actors 104 generate and sequentially transmits probe requests on each channel to be scanned and listens for probe responses from AP actors 102. STA actors 104 may be configured to identify or select an AP and thence a selected AP actor of AP actors 102 with which to associate based on the scanning information obtained through the passive or active scans, and to perform authentication and association operations to establish the communication links 106 with the selected AP actor of AP actors 102. The selected AP actor of AP actors 102 assigns an association identifier (AID) to STA actors 104 at the culmination of the association operations, which selected AP actor of AP actors 102 uses to improve the efficiency of certain signaling to the STA actors 104.

The present disclosure modified the WLAN radio and baseband protocols for the PHY and medium access controller (MAC) layers. AP actors 102 and STA actors 104 transmit and receive wireless communications (hereinafter also referred to as “Wi-Fi communications”) to and from one another in the form of PHY protocol data units (PPDUs). AP actors 102 and STA actors 104 also may be configured to communicate over other frequency bands such as shared licensed frequency bands, where multiple operators may have a license to operate in the same or overlapping frequency band or bands.

Each PPDU is a composite structure that includes a PHY preamble and a payload in the form of one or more PHY service data unit (PSDU). The information provided in the preamble may be used by a receiving device to decode the subsequent data in an intended PSDU. In instances in which PPDUs are transmitted over a bonded channel, selected preamble fields may be duplicated and transmitted in each of the multiple component channels.

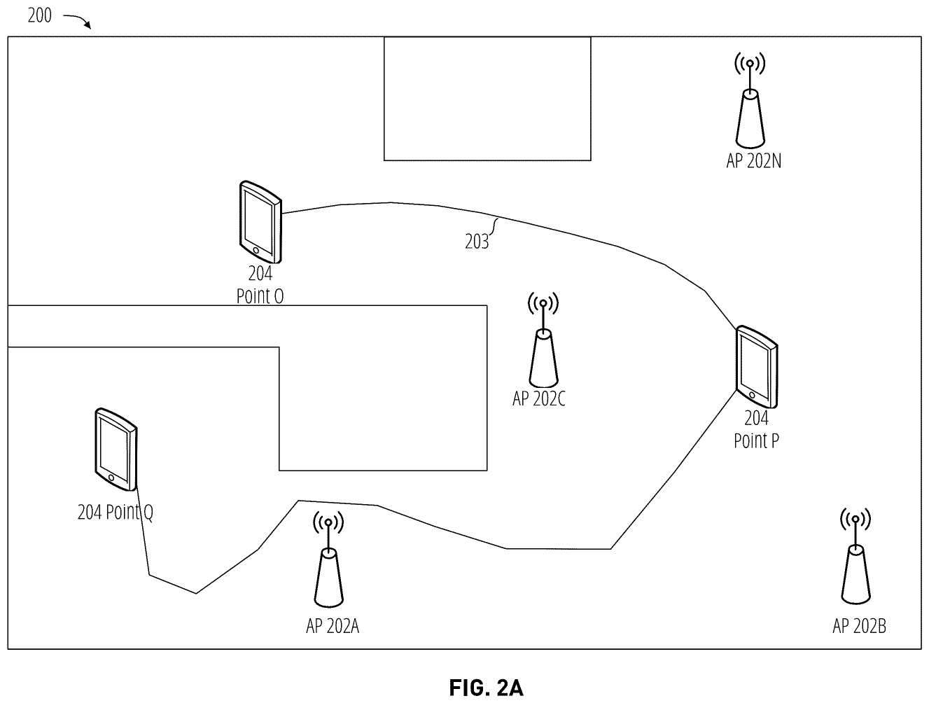

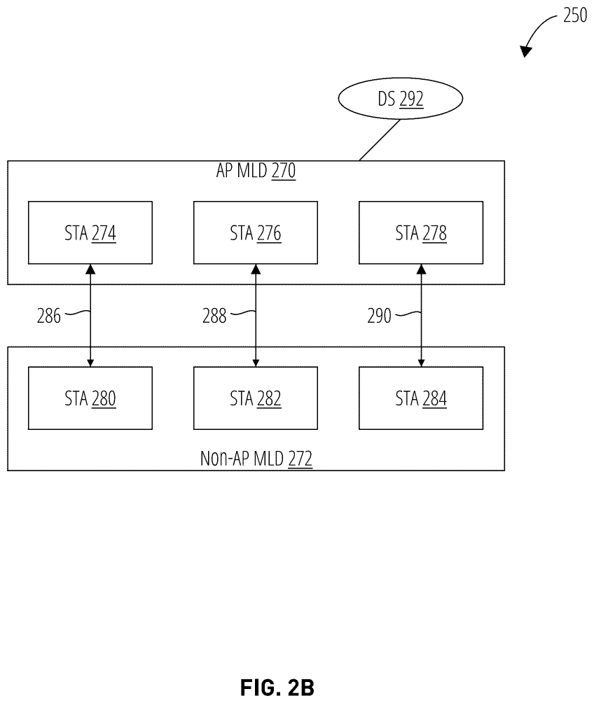

FIG. 2A illustrates an example of a single floor of building equipped with wireless communication according to some aspects of the present disclosure. While only a single floor 200 is illustrated a description equally applies to multiple floors in a building. Additionally, some of the floors in a building may not be contiguous, such that floors 1, 3, 4, and 8 span a network for a building that has floors 1-10. Thus, in at least one implementation the building can include one or more floors that do not have a network including one or more AP actors. As illustrated, the single floor 200 includes AP actors 202A, 202B, 202C, 202N. Each of the AP actors 202A, 202B, 202C, 202N can have a respective coverage area such that an overall coverage area can span substantially the entire floor. In other examples, the overall coverage area can extend beyond the entire floor. In other examples, the overall coverage area can extend beyond the entire floor. Additionally, the coverage of an AP actor of AP actors 202A, 202B, 202C, 202N may substantially overlap with the coverage of another AP actor of the AP actors 202A, 202B, 202C, 202N.

As illustrated by line 203, STA actor 204 can move from point O to point P to point Q. When a STA actor 204 is moving around on a given floor, one or more of AP actors 202A, 202B, 202C, 202N can be considered to be nearest to STA actor 204. Nearest as used in relation to AP actors 202A, 202B, 202C, 202N and STA actor 204 can include being physically nearest (for example, a Euclidean distance on the floor) and/or pathloss-nearest (for example, having the lowest wireless attenuation (pathloss) between AP actor, among all the AP actors, and STA actor). Additionally, the pathloss-nearest approach can be used to reduce the likelihood of connection between an AP actor on a floor above or below STA actor 204. The location of the AP actor on the floor above or below might be closer in a Euclidean sense, but also not be a desirable AP for the connection of the device or station due to the floor location and/or possible signal interruption. The location of the AP actor on the floor above or below might be closer in a straight line and/or Euclidean sense, but also not be a desirable AP for the connection of the device or station due to the floor location and/or possible signal interruption. Additionally, the coverage of one or more AP actors can at least partially overlap with the coverage of one or more other AP actors. The present disclosure provides for selecting the AP actor and/or providing a communication pathway from one or more STA actors through one or more AP actors.

FIG. 2B depicts an illustrative schematic diagram for MLO between an AP MLD with affiliated logical entities and a Non-AP MLD with affiliated logical entities according to some aspects of the present disclosure.

Referring to FIG. 2B, schematic diagram 250 may include two multi-link logical entities AP MLD 270 and Non-AP MLD 272. AP MLD 270 may include physical and/or logical affiliated AP such as AP 274, AP 276, and AP 278 operating in different channels and typically different frequency bands (e.g., 2.4 GHz, 5 GHZ, and 6 GHZ). AP 274, AP 276, and AP 278 may be the same as or similar to any one of the APs described above. Non-AP MLD 272 may include STA 280, STA 282, and STA 284, which may be the same as or similar to any of the STAs as described herein.

AP 274 may communicate with STA 280 via link 286. AP 276 may communicate with STA 282 via link 288. AP 278 may communicate with STA 284 via link 290.

AP MLD 270 is shown in FIG. 2B to have access to a distribution system (DS) such as DS 292, which is a system used to interconnect a set of BSSs to create an extended service set (ESS).

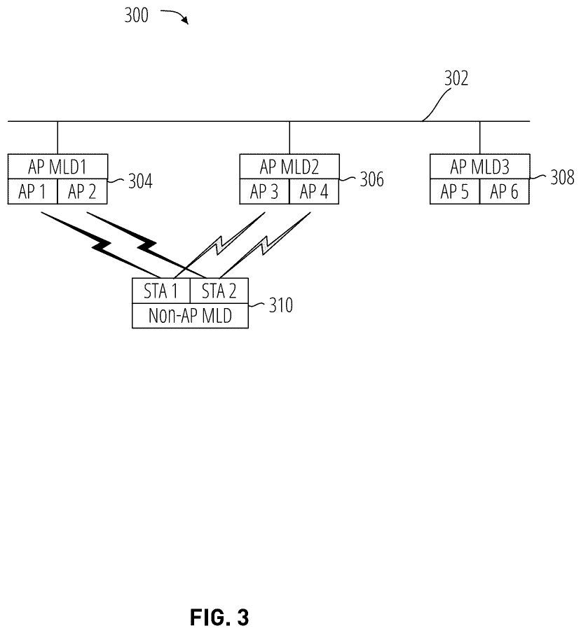

It should be understood that although the example shows three logical entities within the AP MLD and the three logical entities within the Non-AP MLD, this is merely for illustration purposes and that other numbers of logical entities within each of the AP MLD and Non-AP MLD may be envisioned. The example Wi-Fi systems and MLO described above with reference to FIGS. 1 and 2A-B provide examples of simplified and example systems of the present disclosure. Additional details of the present disclosure are provided in relation to FIGS. 3, 4, and 5.

FIG. 3 illustrates an example of a seamless mobility domain according to some aspect of the present disclosure.

FIG. 3 illustrates an example architecture of a Seamless Mobility Domain (SMD) shown as SMD 300 that includes a DS 302 (may be the same as the DS 292) that is a logically connected entity that includes AP MLD1 304, AP MLD2 306, and AP MLD3 308, all of which can form an ESS (e.g., all AP MLDs which are part of a campus ESS network). SMD 300 also shows a Non-AP MLD 310 that may be connected to AP MLD1 304.

AP MLD1 304 may include one or more APs such as AP1 and AP2. AP1 and AP2 may be different physical APs (or AP interfaces) co-located in AP MLD1 304. Similarly, AP MLD2 306 may include one or more APs such as AP3 and AP4. AP3 and AP4 may be different physical APs (or AP interfaces) co-located in AP MLD2 306. Similarly, AP MLD3 308 may include one or more APs such as AP5 and AP6. AP5 and AP6 may be different physical APs (or AP interfaces) co-located in AP MLD3 308. The number of AP MLDs and/or the number of respective APs of each AP MLD is not limited to the example numbers shown in FIG. 2B and may include more or less.

In one example, AP MLD1 304, AP MLD2 306, and AP MLD3 308 may be located in different geographical locations (e.g., different rooms of the same building, different floors of the same building, different buildings of the same campus or area, etc.).

Non-AP MLD 310 may be any known or to be developed device capable of establishing one or more wireless communication links with one or more of AP MLD1 304, AP MLD2 306, and/or AP MLD3 308. As a non-limiting example, Non-AP MLD 310 may be a mobile device having two wireless interfaces, each of which may correspond to one of STA 1 or STA 2. In one example, each one of STA 1 and STA 2 may operate on a different link (e.g., 5 GHz for STA 1 and 6 GHz for STA 2). The number of Non-AP MLDs and/or STAs associated with each is not limited to that shown in FIG. 3 and may be more or less.

As shown in FIG. 3, the Non-AP MLD 310 is associated with the SMD 300 with multiple links setup with the AP MLD1 304 (for example, 2.4 GHz link with the AP1 for the STA 1 and 5 GHz link with the AP2 for the STA 2). For one of the links (for example, 2.4 GHz), Non-AP MLD 310 may detect a weak RSSI. As a result, Non-AP MLD 310 determines a specific roaming target AP3 of AP MLD2 306 for that link to Switch to. Similarly, the same process may be performed for the other link (for example, the 5 GHz) to Switch to a link with STA 4 on the AP MLD2 205.

In order to support seamless link level roaming for an ESS/NID/MDM/SMD (e.g., for MBBR), by way of an example, seamless link level roaming may be initiated by the current AP MLD (e.g., AP MLD1 304). Alternatively, seamless link level roaming may be based upon a request received from the Non-AP MLD (e.g., Non-AP MLD 310). The current AP MLD (may also be referred to as the Source AP MLD) may send a frame, for example, a BSS Transition Management Request frame or any other known or to be developed management frame, to indicate to the Non-AP MLD one or more of: a) one or more ‘delete link’ operations for link(s) of the current AP MLD (in the old MLD's link ID space); and/or b) one or more ‘add link’ operations for link(s) of a new Target AP MLD such as the AP MLD2 306 (in the new MLD's link ID space), wherein the current AP MLD may indicate ‘add link’ operations for multiple candidate Target AP MLDs.

As described herein, the link space can be defined and identified corresponding to each AP MLD by the respective AP MLD MAC Address field included in the Reconfiguration ML element. Accordingly, the frame, such as the BSS Transition Management Request frame, may include multiple Reconfiguration Multi-Link elements. Each Reconfiguration Multi-Link element of the multiple Reconfiguration Multi-Link elements corresponds with each AP MLD for which either a link add, or a link delete operation is indicated in the frame. Further, as described herein, the link add operation may be indicated for multiple roaming candidate Target AP MLDs within the Link Reconfiguration Notify frame. In the Reconfiguration Multi-Link element, the MLD MAC Address may be set to the MLD MAC Address of the AP MLD for which the link add or the link delete operation is indicated.

Support for seamless/smooth roaming capability is a consideration for Wi-Fi 8 to improve Wi-Fi roaming quality. To support smooth roaming/mobility in network (e.g., a geographically dispersed network such as on a campus wide Wi-Fi network), clients can create association with the campus-network/ESS instead of with an individual AP MLD. The ESS might be represented by a mobility domain or, in the case that the network is a global network, then there can be multiple “sub-mobility domains” within a mobility domain, each of which can map to a single campus.

A client such as the Non-AP MLD 310 currently creates its association with the ESS network such as the SMD 300, instead of associating with a single AP MLD (e.g., AP MLD1 304, AP MLD2 306, and/or AP MLD3 308) within the ESS. Such an architecture will enable a client to roam seamlessly between AP MLDs without requiring (re) association and reestablishment of contexts with each new AP MLD, since the client associates with the SMD covering all the AP MLDs of the ESS. Such an architecture can significantly reduce roaming time to realize seamless roaming. Signaling procedures to enable such seamless roaming are described in the present disclosure.

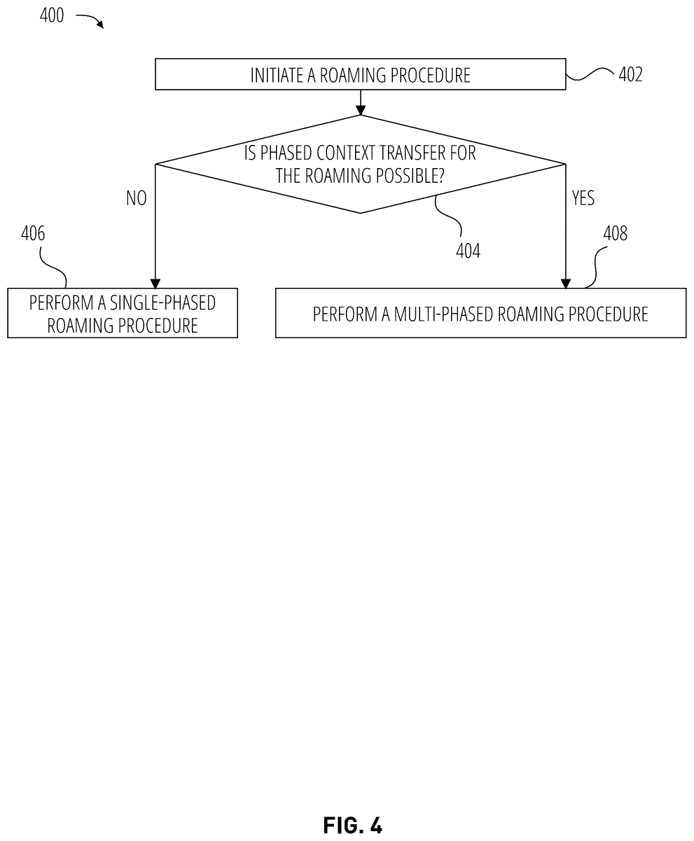

Example embodiments of various wireless network architectures capable of MLO have been described with reference to FIGS. 1, 2A-B, and 3. Next, various example embodiments related enabling seamless roaming with minimal impact on data transfer for a connected end device will be described next with reference to FIGS. 4 through 8. These examples entail various signaling procedures between a Non-AP MLD, a current AP MLD to which the Non-AP MLD is connected, and one or more target AP MLD(s) when a seamless roaming is triggered for the Non-AP MLD, including context transfers (and/or resource reservations) on candidate target AP MLDs in one or more phases. In some examples, static context are transferred during a roaming preparation phase and dynamic context/state is transferred during a roaming execution phase where the data flow might be impacted. Additionally, enhancements are disclosed to provide a time-bound completion for roaming operation to avoid over reserving of resources for a long period of time on potential candidate AP MLDs for roaming.

FIG. 4 illustrates an example method of roaming execution in an MLO wireless network according to some aspects of the present disclosure. The process of FIG. 4 will be described from with reference to one or more components of SMD 300 of FIG. 3. For sake of description, a non-limiting example scenario is assumed when describing the process of FIG. 4. In this non-limiting example, it is assumed that Non-AP MLD 310 is current connected to AP MLD1 304. Therefore, AP MLD1 304 may be referred to as current AP MLD or serving AP MLD. Furthermore, AP MLD2 306 and AP MLD3 308 may be considered as potential AP MLDs to one of which Non-AP MLD 310 may roam should roaming be triggered. Therefore, AP MLD2 306 and AP MLD3 308 may be referred to as Target AP MLDs, roaming AP MLDs, etc. Process 400 may be implemented as follows.

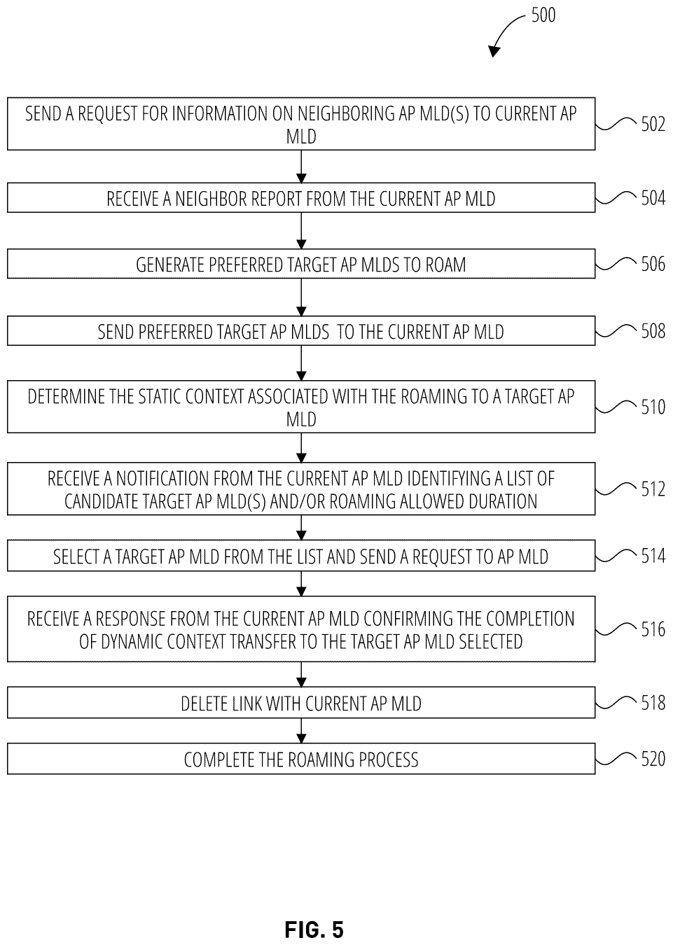

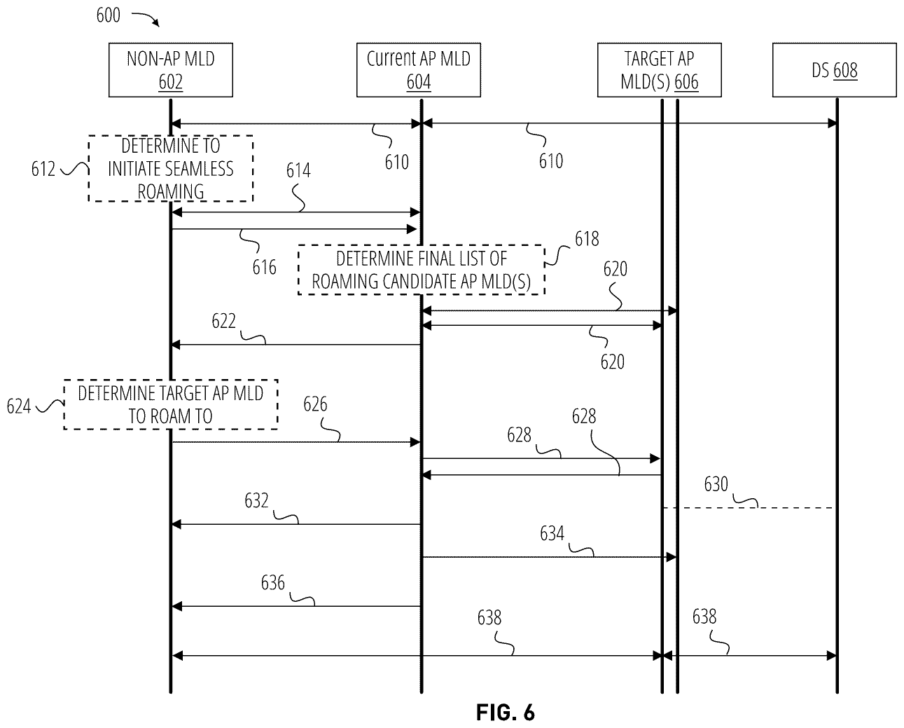

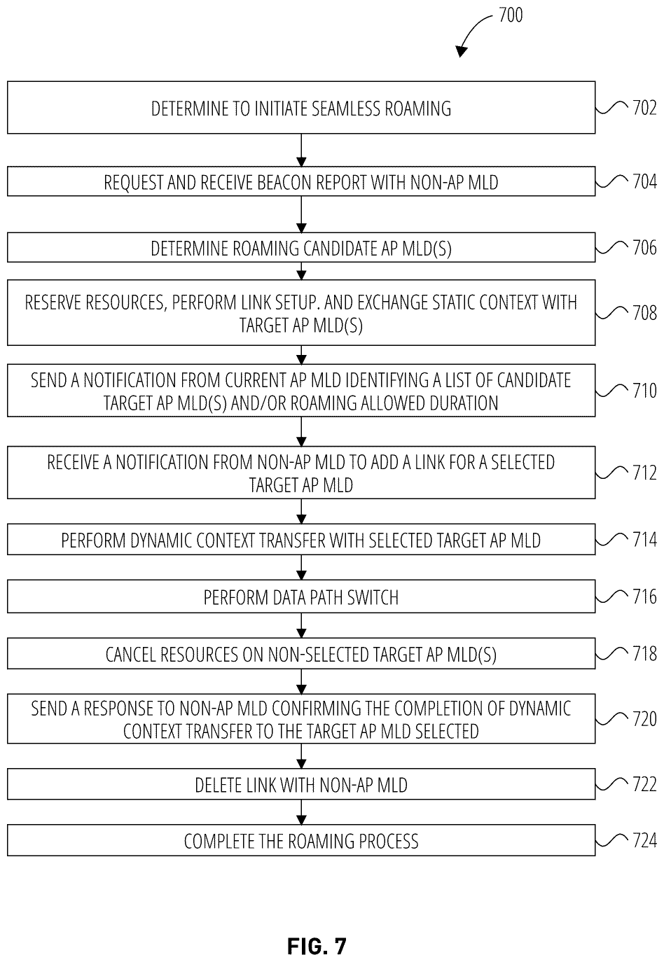

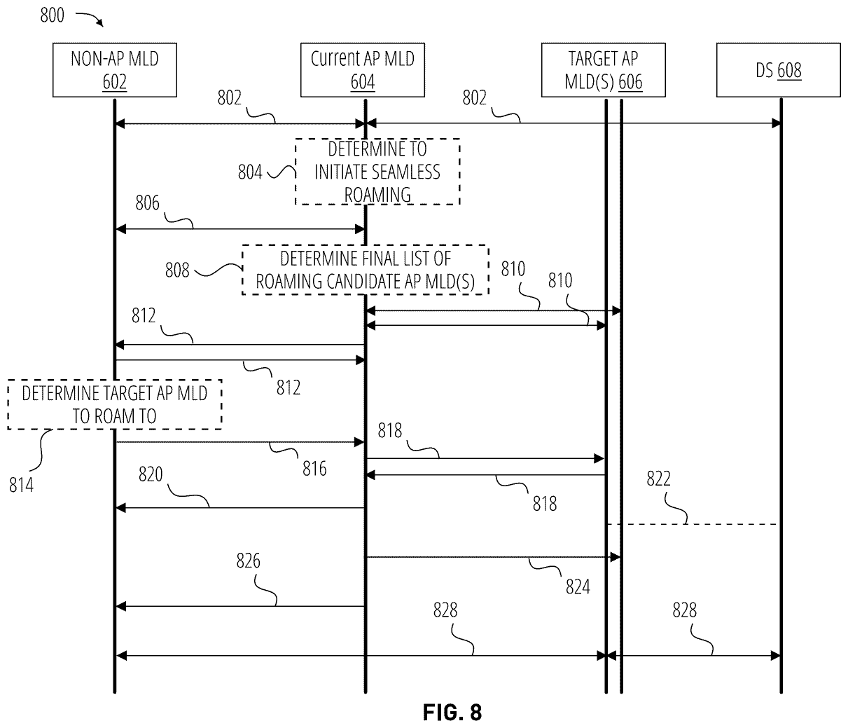

At step 402, a determination may be made to initiate a roaming procedure. In one example, such determination may be performed by Non-AP MLD 310. This may be referred to as client initiated roaming process. In another example, the determination to initiate a roaming procedure may be made by AP MLD1 304. This may be referred to as AP (or AP MLD) initiated roaming procedure. Client initiated roaming procedure will be described in more detail below with reference to FIGS. 5 and 6. AP initiated roaming procedure will be described in more detail below with reference to FIGS. 7 and 8.

In one example, one or more factors may trigger a roaming procedure (seamless roaming) to be initiated. These factors may be referred to as roaming factors and may include, but are not limited to, (1) beacon reports by Non-AP MLD 310 specifying RSSI for one or more AP MLDs including AP MLD1 304, AP MLD2 306, and/or AP MLD3 308, (2) STA capabilities (e.g., STA 1 of Non-AP MLD 310 capabilities and/or STA 2 of Non-AP MLD 310 capabilities). STA capabilities include, but are not limited to, Simultaneous Transmit and Receive (STR), Enhanced Multi-Link Single Radio (EMLSR), etc., and frequency bands that such STA supports, (3) Basic Service Set (BSS) load, average latency, and any other know or to be developed real-time statistics of Target AP MLDs (e.g., AP MLD2 306, AP MLD3 308, etc.), (4) probe response indicating detection of client initiated probe sent on channel(s) of one or more Target AP MLDs, etc. This list of roaming triggering conditions is exemplary only and is not meant to be exhaustive. Any other known or to be developed condition and parameter that can be indicative of a desired and/or necessary roaming of a Non-AP MLD from a current AP MLD to a Target AP MLDs, falls within the scope of the present disclosure.

Once a determination is made that a roaming procedure is to be initiated, at step 404, a determination is made as to whether Non-AP MLD 310 is capable of performing a multi-phased roaming procedure for seamless roaming or not. As will be described below, a multi-phased roaming procedure is one where Non-AP MLD related context (e.g., static v. dynamic context) is transferred from current AP MLD to a target AP MLD and/or negotiated in phases (as will be described in detail with reference to FIGS. 4-8). A first phase of such transfer may be referred to as roaming preparation phase.

As will be described below, in roaming preparation phase, through a series of signaling exchanges between Non-AP MLD 310 and AP MLD1 304, static context to be transferred from AP MLD1 304 to Target AP MLDs is transferred or negotiated, corresponding links are setup, resources on possible candidate Target AP MLDs are reserved by AP MLD1 304.

The second phase may be referred to as roaming execution phase, in which Non-AP MLD 310 selects a Target AP MLD to roam to, AP MLD1 304 and the selected Target AP MLD exchange a number of signals to complete the roaming of Non-AP MLD 310 to selected Target AP MLD. This phase, as will be described below, may include negotiation and/or transfer of dynamic context from Current AP MLD to a selected Target AP MLD and/or DS mapping change to switch the data path for the Non-AP MLD from current AP MLD to the selected target AP MLD.

In some cases, a phased context transfer may not be possible due to detection of an unexpected network performance degradation. For example, Non-AP MLD 310 may experience a sudden drop in RSSI with AP MLD1 304 such that Non-AP MLD 310 does not have time to select a desired Target AP MLDs to roam to, negotiate static context to be transferred from AP MLD1 304 to a Target AP MLDs, have AP MLD1 304 reserve resources on Target AP MLDs, etc.

The determination at step 404 may be made by Non-AP MLD 310. However, it may be possible for this determination to also be made by AP MLD1 304 that serves as the current AP MLD for Non-AP MLD 310.

If, at step 404, a determination is made that a phased context transfer is not possible, at step 406 a single-phased roaming procedure may be carried out. In a single-phased roaming procedure, only roaming execution phase mentioned above (and described below) may be implemented, in which the static context may or may not be transferred or negotiated with the dynamic context from current AP MLD to the selected Target AP MLD. Such transferring, in some examples, may be based on negotiated context to be transferred, between current AP MLD and a selected Target AP MLD. The single-phased roaming procedure may also implement link setup with a selected target AP MLD, along with context transfer/negotiation. This will be described in more detail below as well.

However, if at step 404, a determination is made that a multi-phased context transfer is possible, at step 408, a multi-phased roaming procedure may be carried out (implemented). Detailed examples of a multi-phased roaming procedure will be described below with reference to FIGS. 5-8.

FIG. 5 illustrates an example process of a client initiated multi-phased roaming procedure according to some aspects of the present disclosure. Process of FIG. 5 will be described with reference to FIGS. 3 and 4.

Example process 500 may start at step 502, where Non-AP MLD 310 sends a request for information on neighboring AP MLDs to AP MLD1 304 that is serving as the current AP MLD for Non-AP MLD 310. Neighboring AP MLDs may include one or more additional APs of AP MLD1 304 (e.g., AP 2 of AP MLD1 304), one or more Target AP MLDs that are in geographical vicinity of Non-AP MLD 310 (e.g., AP MLD2 306, AP MLD3 308, etc.).

At step 504, Non-AP MLD 310 may receive a neighbor report from AP MLD1 304 that identifies one or more neighboring AP MLDs. In one example, the information on neighboring AP MLDs received from the current AP MLD1 304 may be used by the Non-AP MLD for a roaming preparation procedure.

At step 506, Non-AP MLD 310 may generate a preferred Target AP MLDs list, which may indicate one or more preferred Target AP MLDs that Non-AP MLD 310 may roam to. This preferred list of Target AP MLDs may be determined by Non-AP MLD 310 according to any known or to be developed method. As a non-limiting example, Target AP MLDs may use a threshold RSSI, a threshold throughout, a threshold SNR, etc., as conditions to make determination for the preferred Target AP MLDs.

In some examples, Target AP MLDs preferences may be determined using one or more machine learning techniques, whereby past performance and/or parameters of connections between Non-AP MLD 310 and AP MLDs are analyzed and considered for determining one or more desired preferences of future AP MLDs for Non-AP MLD 310 to roam to.

At step 508, Non-AP MLD 310 may send the preferred Target AP MLDs generated at step 506, to AP MLD1 304. In one example, the request sent at step 508 may be referred to as a roaming preparation request that may be sent via any known or to be developed signaling frame (e.g., an add link request frame, a link reconfiguration request frame, a link reconfiguration notify frame or another management frame). In response and based at least in part of Target AP MLDs preferences received, AP MLD1 304 may determine one or more candidate Target AP MLDs for possible roaming of Non-AP MLD 310 thereto.

In some examples, if the number of candidate Target AP MLDs is more than one, AP MLD1 may generate a ranked list of candidate Target AP MLDs. Various examples of such ranking will be further described below.

Upon determining the candidate Target AP MLDs, Non-AP MLD 310 may perform resource reservations on each of candidate Target AP MLDs along with performing a transfer of static context to each candidate Target AP MLDs.

In one example, AP MLD1 304 may perform static context transfer and resource reservation on candidate Target AP MLDs using AP to AP exchange over wired (e.g., 802.1/IP) infrastructure. The context transferred at this stage is static or near static context information (e.g., information or parameters that remain consistent across different AP MLDs during the handover process in a Wi-Fi network). Static information may include, but is not limited to, STA capabilities, Block Acknowledgment (BA) agreements, Spatial Channel Sensing (SCS) and Quality of Service (QOS) Characteristics, Target Wait Time (TWT) agreements (e.g., Individual TWT (iTWT), broadcast TWT (bTWT), and Restricted-TWT (R-TWT)), negotiated Traffic Identifier (TID)-to-Link Mapping (TTLM), Security Association (SA) context that may include Pairwise Master Key Security Association (PMKSA) and/or Pairwise Transient Key Security Association (PTKSA), etc.

In another example, the static context information may be exchanged over-the-air (e.g., 802.11) between AP MLD1 304 and candidate Target AP MLDs using new or existing management frames since it may be faster to exchange in this way as opposed to via the wired network due to factors such as host processor delays if the channel utilization is low, etc. In one example and simultaneously with such context transfer procedure, at step 510, Non-AP MLD 310 may determine to negotiate one or more static context to be sent by AP MLD1 304 to candidate Target AP MLDs. In addition, resources to be reserved on candidate Target AP MLDs may also be requested (negotiated) by Non-AP MLD 310. For instance, STA 1 of Non-AP MLD 310 may request any one of, a subset of, or all of the non-limiting example static parameters mentioned above, to be transferred (or negotiated) by AP MLD1 304 to candidate Target AP MLDs. For example, static context can include, but is not limited to block acknowledgement agreements setup for the Non-AP MLD; stream classification service (SCS) streams setup for the Non-AP MLD; mirrored stream classification service (MSCS) streams setup for the Non-AP MLD; target wake time (TWT) agreements setup for the Non-AP MLD; TID-to-link mapping (TTLM) agreements setup for the Non-AP MLD, security association context associated with the Non-AP MLD, and/or any known or to be developed capabilities of the Non-AP MLD

In on example, the determination at step 510 may include transferring one or more static context (first one or more static context) associated with Non-AP MLD 310 to one or more candidate target AP MLDs from among which a target AP MLD may be selected. Examples of one or more static context have been described above and are provided below as well. The transferring may be performed directly from Non-AP MLD 310 to candidate target AP MLDs (e.g., AP MLD2 306 and AP MLD3 308) or may be transferred via Current AP MLD1 304.

In another example, the determination at step 510 may include negotiating the one or more static context (second one or more static context) associated with the Non-AP MLD with one or more candidate target AP MLDs. The negotiation can be performed directly between Non-AP MLD 310 and candidate target AP MLDs (e.g., AP MLD2 306 and AP MLD3 308) or alternatively may be performed between Current AP MLD1 304 and candidate target AP MLDs (e.g., AP MLD2 306 and AP MLD3 308).

In one example, first one or more dynamic context may or may not be the same as second one or more static context. In another example, second one or more static context may be a subset of the first one or more static context (or a modified version of the first one or more static context).

In one example, the determination at step 510 may include setting up one or more links (one or more first links) for Non-AP MLD 310 with one or more of candidate target AP MLDs (e.g., AP MLD2 306 and AP MLD3 308).

In some examples, one of, one or more of, or all of (i) transferring the one or more static context (first one or more static context), (ii) negotiating of one or more static context (second one or more static context), (iii) setting up the one or more first links, and/or (iv) reserving resources on candidate target AP MLDs, may be performed.

In one example, one or more of candidate target AP MLDs (e.g., AP MLD2 306 and AP MLD3 308), target AP MLD that is selected, and Current AP MLD1 304 are associated with the same SMD (e.g., SMD 300).

In one example, the request (negotiation) sent at 508 by Non-AP MLD 310 may be performed as part of a Roaming Notification frame or a Link Reconfiguration frame (or another management frame) which indicates to AP MLD1 304 that Non-AP MLD 310 is requesting to start the roaming preparation procedure. In one example, such Roaming Notification can indicate following:
A list of candidate Target AP MLDs and links (e.g., 2.4 GHz, 5 GHZ, 6 GHZ, etc.) desired to be added for each of the candidate Target AP MLDs and/or a preference indication for each candidate Target AP MLDs.
Set of near static context to be transferred to each candidate Target AP MLDs. In one example, this set of static context may be communicated using a bitmap where each bit indicates what type of context should be transferred.
Set of near static context to be negotiated with each candidate Target AP MLDs.
For TWT, additional information may be provided for each target AP MLD on which links the TWT agreements is to be transferred.
Non-AP MLD 310 can also indicate a desired roaming time duration before which a STA of Non-AP MLD 310 need to initiate the roaming with one of the candidate target AP MLDs.

Example bitmap shown below may be used by Non-AP MLD 310 to indicate the set of near static context to be transferred by AP MLD1 304 to each candidate Target AP MLDs.

| | | | | | | |
|---|---|---|---|---|---|---|
| Transfer | Transfer | Trasnfer | Transfer | Transfer | Transfer | Transfer |
| STA | BA | SCS and | iTWT | bTWT | R-TWT | Negotiated |
| Capabilities | Agreements | QoS | Agreements | Agreements | Agreements | TTLM |
| | | Characteristics | | | | |

Example bitmap shown above is just one example where a series of specific near static context are specified. However, the present disclosure is not limited thereto. In some embodiments, the near static context may be communicated in a more generalized manner or more specific. For instance, Non-AP MLD 310 may simply indicate that all TWT Agreements are to be transferred instead of specifying each one as shown above.

As noted above, AP MLD1 304, along with transferring static context, may also reserve certain resources (control resources) on each candidate AP MLD for a possible roaming of Non-AP MLD 310 to such candidate AP MLD. Such resources may include any known or to be developed resources on a candidate Target AP MLDs for a successful roaming of Non-AP MLD 310 thereon.

Once the static context transfer and/or negotiation and/or resource reservation is complete, at step 512 Non-AP MLD 310 may receive a notification from AP MLD1 304. In one example, the notification may be referred to as a roaming preparation response that may be sent via any known or to be developed signaling frame (e.g., an add link response frame, a link reconfiguration response frame, a link reconfiguration notify frame or another management frame). The notification received at step 512 may identify a list of one or more candidate Target AP MLDs that Non-AP MLD 310 can select from to roam to.

In one example, in addition to receiving the list, at step 512, Non-AP MLD 310 also receives a roaming allowed duration (RAD). RAD may be specific to and/or unique for each candidate Target AP MLDs or may be the same for all candidate AP MLDs. RAD may specify a window of time (e.g., a few milliseconds, one or more seconds, etc.) during which Non-AP MLD 310 must complete a roaming process. If a roaming is not completed within RAD, resources reserved on candidate AP MLDs may be canceled and hence roaming may fail. In one example, AP MLD1 304 may cancel resources reserved on candidate Target AP MLDs. Alternatively, resources are automatically cancelled on candidate Target AP MLDs after some default time duration equal to or larger than RAD. Such default time duration may be determined based on experiments and/or empirical studies.

In one example, RAD can be specified in Time Unit (TU), for example, 100 TUs. RAD may also be determined based at least in part on a roaming time duration specified by Non-AP MLD 310 at step 506, that specifies a preference of the Non-AP MLD for the window of time allowed for roaming.

In one example, resource negotiation may fail with some nearby candidate target AP MLDs due to not enough resources being available. Such candidate target AP MLDs may not be included in the list received at step 512. Information on excluded candidate Target AP MLDs may be provided to a STA of Non-AP MLD 310 as part of a Roaming Notification (or another management frame) which can be sent unsolicited to the STA or as a response to the Roaming Notification (or another management frame) received from the STA at step 508.

Response to Roaming Notification (or another management frame) at 512 may further indicate to the STA that roaming candidate Target AP MLDs have been setup with one or more requested links, the context information and resources. This frame can also indicate what contexts were transferred from the source AP MLD to candidate Target AP MLDs based on bitmap for context transfer and additional fields/elements as defined above.

In one example, an STA of Non-AP MLD 310 can optionally indicate whether the STA accepts the Roaming Notification from AP MLD1 304 by sending a response to Roaming Notification received from AP MLD1 304.

The Roaming Notification can be designed by leveraging and enhancing Link Reconfiguration Notify frame or Link Reconfiguration Request and Response frames as defined in 802.11be draft.

In one example, step 502, step 504, step 506, step 508, step 510, and step 512 may collectively correspond to the roaming preparation phase identified above. Thereafter, roaming execution phase may be initiated. In one example, the roaming preparation procedure may be initiated by Non-AP MLD 310 and/or Current AP MLD1 304.

At step 514, Non-AP MLD 310 may select a Target AP MLD from the list of candidate Target AP MLDs received at step 512. When the list includes more than one candidate Target AP MLDs (e.g., AP MLD2 306 and AP MLD3 308), Non-AP MLD 310 may perform a selection of a Target AP MLD with the better performance parameter (e.g., highest RSSI, throughput, etc.). Alternatively, the selection may be random (e.g., when performance parameters of all candidate Target AP MLDs are the same) or based on other factors.

Upon selection of a Target AP MLDs from the list, at step 514, Non-AP MLD 310 may send a request to AP MLD1 304. The request may be referred to as a Roaming Execution request sent via any known or to be developed signaling frame (e.g., an add link request frame, a link reconfiguration request frame, a link reconfiguration notify frame, or another management frame etc.) and may identify the selected Target AP MLD (e.g., AP MLD2 306). The request may further include a desired link(s) to be setup with the selected Target AP MLDs (e.g., one or more of a 2.4 GHz link, 5 GHz link, 6 GHz link, etc.) if different than the links setup in the roaming preparation phase.

In response to receiving the request, AP MLD1 304 may perform a dynamic context transfer to the selected Target AP MLD. Dynamic context may include parameters and state-specific data that are updated or renegotiated when Non-AP MLD 310 transitions from Current AP MLD1 304 to a target AP MLD (such as target AP MLD2 306). For example, dynamic context may include, but is not limited to, one or more Sequence Numbers (SN), one or more Packet Number (PN), one or more block acknowledgement agreements (block ack) and related context, one or more duplicate receiver caches corresponding to the data (DL and/or UL) associated with Non-AP MLD 310, etc. By sending the most dynamic context at this step of roaming execution phase, roaming time and associated data interruption may be reduced. In one example, the AP MLD1 304 may also negotiate one or more dynamic context (to be transferred) with the selected Target AP MLD. In one example, the one or more dynamic context includes at least one of one or more Sequence Numbers (SN), one or more Packet Number (PN), one or more block acknowledgement agreements (block ack) and related context, one or more duplicate receiver caches corresponding to the data (DL and/or UL) associated with Non-AP MLD 310, etc. Dynamic context is not limited to these and may include any other known or to be developed dynamic context.

Similar to the static context, in one example, AP MLD1 304 transfers one or more dynamic context (first one or more dynamic context) to the selected Target AP MLD. In another example, AP MLD1 304 negotiates one or more dynamic context (second one or more dynamic context) to the selected Target AP MLD. First one or more dynamic context may or may not be the same as second one or more dynamic context. In another example, second one or more dynamic context may be a subset of the first one or more dynamic context (or a modified version of the first one or more static context).

In another example, AP MLD1 304 sets up one or more links (one or more second links) for Non-AP MLD 310 with the selected Target AP MLD. Any one or more of second links may or may not be the same as one or more first links set up during roaming preparation phase as described above.

In some examples, one of, one or more of, or all of (i) transferring the one or more dynamic context (first one or more dynamic context), (ii) negotiating of one or more dynamic context (second one or more dynamic context), (iii) setting up the one or more first links, and/or (iv) reserving resources on candidate target AP MLDs, may be performed.

At step 516, Non-AP MLD 310 may receive a response from AP MLD1 304 confirming completion of the dynamic context transfer to the selected Target AP MLDs. The response may be referred to as a Roaming Execution response sent via any known or to be developed signaling frame (e.g., an add link response frame, a link reconfiguration response frame, a link reconfiguration notify frame, or another management frame etc.). In one example, this response can include an Association ID (AID) assigned to the STA and groups keys for links added for the STA on the Target AP MLD.

In one example, DS data path is then switched from the AP MLD1 304 to the selected Target AP MLD (e.g., AP MLD2 306). In response, at step 518, current link with AP MLD1 304 is deleted.

The deletion of the current link(s) may be completed by sending a Roaming Delete Link Request from AP MLD1 304 to Non-AP MLD 310. The Delete Link indication can be combined with the Roaming Add Link Response at step 516 or sent separately after DL data has been drained from the AP MLD1 304. In one example, the deletion of link(s) with current AP MLD may be done using explicit signaling exchange between the current AP MLD and the Non-AP MLD at step 518. In another example, the deletion of link(s) with current AP MLD may be done implicitly based on a timer duration that can be indicated by the current AP MLD to the Non-AP MLD in the response at step 516.

At step 520, the multi-phased roaming process is complete and new link(s) of Target AP MLD (e.g., AP MLD2 306) are ready for Uplink (UL) and Downlink (DL) transmission for the Non-AP MLD.

In one example, Roaming Add Link Request/Response and Roaming Delete Link Request/Response can be designed by leveraging and enhancing Link Reconfiguration Request/Response frames or Link Reconfiguration Notify frame as defined in 702.11be draft or these can be new management frames defined for roaming.

FIG. 6 illustrates an example of a signaling exchange between a Non-AP MLD and a current AP MLD for performing seamless roaming process according to some aspects of the present disclosure. Example signaling exchange of FIG. 6 may be performed between Non-AP MLD 602 (which may be the same as Non-AP MLD 310), Current AP MLD 604 (which may be the same as, for example, AP MLD1 304 that is used as an example of a current AP MLD in describing the process of FIG. 5), one or more Target AP MLDs 606 (which may be the same as AP MLD2 306 and AP MLD3 308) that may be part of the same SMD as Current AP MLD 604, and DS 608 (which may be the same as DS 302).

Example exchange 600 may include exchange 610 between Non-AP MLD 602, Current AP MLD 604 to which Non-AP MLD 602 is connected, and DS 608. This exchange includes any UL/DL transmissions of network traffic to and from STAs of Non-AP MLD 602 according to known or to be developed methods.

At some point (e.g., at 612), Non-AP MLD 602 may determine to initiate a seamless roaming process as described above with reference to, for example, step 402 of FIG. 4.

In one example, initiating a seamless roaming process by Non-AP MLD 602 may be triggered upon receiving a report from Current AP MLD 604. Such report may be generated based on observed network conditions and parameters associated with the quality of connection of Non-AP MLD 602 with Current AP MLD 604 and/or other AP MLDs that are available. Upon receiving a report, Non-AP MLD 602 may determine to initiate seamless roaming process.

Upon making this determination, signaling exchange 614 may take place between Non-AP MLD 602 and Current AP MLD 604. For instance, and as one non-limiting type of signaling type, Non-AP MLD 602 may request a Neighbor Report from Current AP MLD 604 and in response may return such list from Current AP MLD 604. For example, the list may include identification of several available Target AP MLDs.

Upon receiving the report, Non-AP MLD 602 may determine a list of desired candidate Target AP MLDs determined by Non-AP MLD 602 from the report. This list of desired candidates may be determined according to any known or to be developed method by Non-AP MLD 602 and may be sent to Current AP MLD 604 using signaling exchange 616. A non-limiting example of signaling exchange 616 is a Roaming Notification.

In another example, instead of Roaming Notification, Link Reconfiguration request and response frames may be used during roaming preparation phase. In such case, the Link Reconfiguration request can include one or more Reconfiguration ML element(s) indicating links for setup with one or more candidate target AP MLDs along with a preference order of desired candidates as well as include additional information. For example, the Link Reconfiguration request may be modified to further include a seamless mobility domain element (SMDE) identifying the SMD, a set of Roaming control information that includes preparation indication, a Roaming Sequence Number, context transfer indication indicating the set of contexts to be transferred, resource reservation request, context negotiation request etc.)

After receiving the Roaming notification, at 618, Current AP MLD 604 may determine a final list of candidate Target AP MLDs as described above with reference to FIG. 5. This list may include Target AP MLDs 606

Once the list is determined, Current AP MLD 604 may perform signaling exchanges 620 with Target AP MLDs 606 to transfer one or more static context and reserve resources on candidate Target AP MLDs 606 as described above, and/or to perform negotiation of one or more static context with the candidate Target AP MLDs 606 and to setup link(s) with the candidate Target AP MLDs 606.

Static context transfer, resource reservation and link setup may include the following procedures.
Transfer of near static context (or any selected context information) to one or more candidate target AP MLDs for roaming in the future.
Pre-setting up links on one or more candidate target AP MLDs for roaming in the future. The links are not activated yet and 802.1x port is not open for data transfer.
Optional resource reservation for one or more resources on the candidate target AP MLDs for a time period (may be shown as Roaming Execution Timer).
The resources reserved may include the pre-assignment of setup links for Non-AP MLD 602.
Reserving QoS resources for one or more SCS streams as requested by Non-AP MLD 602 or selected by Current AP MLD 604.
Reserving resources for TWT agreements, either existing TWT agreements that are requested to be transferred to specific links by Non-AP MLD 602 or new TWT agreements that are requested to be negotiated by Non-AP MLD 602.
Reserving Block Acknowledgment resources.
Reserving any other resources requested by Non-AP MLD 602 or selected by Current AP MLD 604.

As noted above with reference to FIG. 5, simultaneously or near simultaneously with static context transfer and resource reservation, the static context to be transferred to candidate Target AP MLDs may be specified by Non-AP MLD 602 and Current AP MLD 604 (negotiated between them).

Thereafter, signaling exchange 622 may occur wherein Current AP MLD 604 sends a Roaming Notification to Non-AP MLD 602 that includes an indication of one or more of (a list of) candidate Target AP MLDs that may be listed in the preference order, an indication of set of one or more static context that were transferred to the candidate target AP MLDs, an indication of one or more context that were negotiated with the candidate target AP MLDs, an indication of resources reserved at the candidate target AP MLDs, and/or or RAD as described above.

In example embodiments where Link Reconfiguration Request is used for roaming preparation, a corresponding Link Reconfiguration Response may include ML element(s) (e.g. Basic Multi-link element or Reconfiguration ML element) for one or more target AP MLDs, an SMDE (seamless mobility domain element), Roaming Control information that includes one or more of status (e.g. accept/reject) for roaming preparation, a roaming preparation indication, a Roaming Sequence Number (SN), context transfer indication that indicates the set of context that were transferred, context negotiation indication that indicates one or more context that were negotiated with the candidate target AP MLDs, resource reservation indication indicating the set of resources reserved, RAD/Roaming Execution Timer, etc.).

Roaming SN may be used to tie roaming preparation phase with the roaming execution phase.

Once signaling exchange 622 is complete, roaming preparation phase may be considered complete.

Thereafter, at step 624, Non-AP MLD 602 may determine a target AP MLD to roam to from among the list of candidate Target AP MLDs received as part of signaling exchange 622. For example, Non-AP MLD 602 may select AP MLD2 306 as the target AP MLD to roam to. Once step 624 is performed, the roaming execution may be triggered when Non-AP MLD 602 sends signaling exchange 626 to Current AP MLD 604.

Using signaling exchange 626, Non-AP MLD 602 may send a Roaming execution request (e.g., an Add Link Request, a Link Reconfiguration request, etc.) to Current AP MLD 604 to request roaming to the selected target AP MLD along with one or more requested links to be established with target AP MLD. The set of links requested may be same as the links setup in the roaming preparation phase with the target AP MLD. In such a case, the Non-AP MLD may omit including set of links again and indicate to perform roaming with the links that are already setup in the roaming preparation phase.

After Current AP MLD 604 receives the Roaming execution request (e.g., an Add Link Request, a Link Reconfiguration request, etc.), the signaling exchanges 628 may take place between Current AP MLD 604 and target AP MLD (e.g., one of Target AP MLDs 606). This exchange may be performed according to any known or to be developed signaling procedure whereby, Current AP MLD 604 confirms the roaming with selected target AP MLD and exchanges dynamic context (e.g., SN and/or PN) with selected target AP MLD.

During the dynamic context transfer, in parallel, the target AP MLD may initiate a DS (distribution system) mapping change to switch the data path for the Non-AP MLD from the current AP MLD to the target AP MLD. The DS mapping change may be completed via signaling exchange 630 between target AP MLD 606 and DS 608, as described above.

Once DS mapping update has been initiated for data path switch for Non-AP MLD 602, using signaling exchange 632, Current AP MLD 604 may send a Roaming execution response (e.g., Add Link response, Link reconfiguration response, etc.) to Non-AP MLD 602 to confirm that roaming execution and dynamic context transfer as part of that process is complete.

Current AP MLD 604 may then cancel resources reserved on other candidate Target AP MLDs (which occurred along with static context transfer using signaling exchanges 620), using signaling exchange 634. Alternatively, the resource reservation (and links setup) on other candidate target AP MLDs can expire automatically (e.g., upon expiration of a timer which may be the same or different than RAD).

In another example, Link Reconfiguration request and response frames may be used in the roaming execution phase. In such case, Link Reconfiguration request frame may be sent as part of signaling exchange 626 and may be modified to include, in addition to the Reconfiguration ML element for the Target AP MLD, an SMDE, a Roaming control that includes one or more of a field for execution indication, a Roaming SN to tie the roaming execution phase with the roaming preparation phase, a context transfer indication indicating set of context to be transferred, context negotiation indication that indicates one or more context that to negotiate with the target AP MLD etc.). In one example, STA Profile in Reconfiguration ML element may be omitted when the set of links being setup with the target AP MLD is the same as in the roaming preparation phase.

Accordingly, the Link Reconfiguration Response frame may be sent as part of signaling exchange 632 and may have one or more ML element(s) (e.g., Basic ML element or Reconfiguration ML element) for the Target AP MLD, an SMDE, a Roaming control indicating status of the roaming execution (e.g. accept/reject), a execution phase indication, a Roaming SN, a context transfer indication indicating set of context that were transferred to the target AP MLD, Group Keys of the links setup with the target AP MLD, an AID (association identifier) assigned to the Non-AP MLD by the target AP MLD. In one example, STA Profile in Reconfiguration ML element may be omitted when the set of links being setup with the target AP MLD is/are the same as in the roaming preparation phase. Roaming SN may be used to tie roaming preparation phase with roaming execution phase.

Thereafter, using signaling exchange 636, Current AP MLD 604 may send a Roaming Delete Link message to Non-AP MLD 602 to delete existing link(s) between Current AP MLD 604 and Non-AP MLD 602. In another embodiment, the explicit link deletion step may be skipped and link deletion may be done implicitly based on a timer value specified by the current AP MLD in the roaming execution response. At this point, UL/DL transmissions may be performed between Non-AP MLD 602, selected Target AP MLD from among Target AP MLDs 606, and DS 608 using signaling exchanges 638.

In a multi-phased roaming procedure, after roaming preparation phase is complete, roaming execution phase may be canceled for any number of reasons. For instance, Non-AP MLD 602 may change its target AP MLD selection due to changes Non-AP MLD 602 observes in RSSI and/or channel load of Current AP MLD 604 or other neighboring AP MLDs/APs, etc.

In this case, Non-AP MLD 602 may desire to cancel the previous roaming preparation and start another roaming procedure (roaming preparation+roaming execution phases). To do so, Non-AP MLD 602 may use the Roaming SN to signal that Non-AP MLD 602 is starting a new roaming procedure. Non-AP MLD 602 may then increment its Roaming SN and use that value in the next roaming procedure Non-AP MLD 602 starts with Current AP MLD 604.

When Current AP MLD 604 receives a roaming preparation request or a roaming execution request with an incremented Roaming SN, that also signals to Current AP MLD 604 to implicitly cancel the previous roaming preparation done by Non-AP MLD 602. Therefore, the Roaming SN can be used to implicitly cancel a previous roaming preparation phase when Non-AP MLD 602 wants to change its roaming selection and start a new roaming procedure with a different set (one or more) of target AP MLDs. In another embodiment, the Non-AP MLD may send an explicit signaling to the current AP MLD to cancel a previous roaming preparation if it desires to start another roaming procedure.

FIG. 7 illustrates an example process of an AP MLD initiated multi-phased roaming procedure according to some aspects of the present disclosure. Process of FIG. 7 may be similar to process of FIG. 5 for executing a multi-phased roaming process (including a roaming preparation phase and roaming execution phase) except that process of FIG. 7 is performed from the perspective of AP MLD1 304 that is currently serving Non-AP MLD 310. Process of FIG. 7 will be described with reference to one or more of FIGS. 3-6.

Example process 700 may start at step 702, where AP MLD1 304 determines to initiate a roaming process. This determination may be performed in the same manner as described above with reference to step 402 of FIG. 4.

At step 704, AP MLD1 304 may request and receive a Beacon report with Non-AP MLD 310 to receive capabilities of Non-AP MLD 310 and receive information about the target AP MLDs that are visible at the Non-AP MLD, for purposes of identifying and selecting potential Target AP MLDs for Non-AP MLD 310 to roam to. Capabilities of Non-AP MLD 310 may include any known or to be developed capabilities that may be indicative of the ability of Non-AP MLD 310 to establish a connection to a given AP MLD.

At step 706, AP MLD1 304 determines candidate Target AP MLDs, in a similar manner as described above with reference to FIGS. 5 and 6. In one example, step 706 is start of roaming preparation procedure initiated by the AP MLD1 304.

At step 708, AP MLD1 304 performs static context transfer (that may have been or may simultaneously be negotiated with Non-AP MLD 310), link setup for one or more links and resource reservation on candidate Target AP MLDs in the same manner as described above with reference to FIGS. 5 and 6.

At step 710, AP MLD1 304 sends a notification to Non-AP MLD 310 identifying the list of candidate target AP MLD(s) and associated RAD(s), in the same manner as described above with reference to FIGS. 5 and 6.

In response, Non-AP MLD 310 performs a process to select a target AP MLD as described above and, at step 712, AP MLD1 304 receives a notification or request from Non-AP MLD 310 to request one or more desired link(s) to be added for the selected target AP MLD. In one example, step 712 is start of roaming execution procedure initiated as described above with reference to FIGS. 5 and 6.

In response, at step 714, AP MLD1 304 performs a dynamic context transfer or negotiation of dynamic context with the selected target AP MLD in the same manner as described above with reference to FIGS. 5 and 6. In one example, at step 714, one of more links are setup with the selected target AP MLD, if not already setup in a roaming preparation procedure or if links are different than the links setup in the roaming preparation procedure.

At step 716, AP MLD1 304 performs data path switch as described above with reference to FIGS. 5 and 6. In one example, data path switch may include changing the distribution system (DS) mapping to switch the data path for Non-AP MLD 602 from Current AP MLD 604 to the selected target AP MLD 606. This process may be performed between the selected target AP MLD 606 and DS 608.

At step 718, AP MLD1 304 cancels resources reserved at step 708, on candidate Target AP MLDs that were not selected by Non-AP MLD 310, in a same manner as described above with reference to FIGS. 5 and 6.

At step 720, AP MLD1 304 sends a response to Non-AP MLD 310 confirming the completion of dynamic context transfer to the selected target AP MLD (e.g., AP MLD2 306) in the same manner as described above with reference to FIGS. 5 and 6.

At step 722, AP MLD1 304 deletes existing link(s) between Non-AP MLD 310 and AP MLD1 304 in the same manner as described above with reference to FIGS. 5 and 6.

At step 724, AP MLD1 304 completes the multi-phased roaming procedure after which Non-AP MLD 310 performs UL/DL transmissions with the selected target AP MLD that Non-AP MLD 310 has now roaming to.

FIG. 8 illustrates an example of a signaling exchange between a Non-AP MLD and a current AP MLD for performing seamless roaming process according to some aspects of the present disclosure. Example signaling exchange of FIG. 6 may be performed between Non-AP MLD 602 (which may be the same as Non-AP MLD 310), Current AP MLD 604 (which may be the same as, for example, AP MLD1 304 that is used as an example of a current AP MLD in describing the process of FIG. 5 and/or FIG. 7), one or more Target AP MLDs 606 (which may be the same as AP MLD2 306 and AP MLD3 308) that may be part of the same SMD as Current AP MLD 604, and DS 608 (which may be the same as DS 302).

Example exchange 800 may include exchange 802 between Non-AP MLD 602, Current AP MLD 604 to which Non-AP MLD 602 is connected, and DS 608. This exchange includes any UL/DL transmissions of network traffic to and from STAs of Non-AP MLD 602 according to known or to be developed methods.

At some point (e.g., at 804), Current AP MLD 604 determines to initiate a seamless roaming process as described above with reference to, for example, step 402 of FIG. 4.

Upon making this determination, signaling exchange 806 may take place between Non-AP MLD 602 and Current AP MLD 604. For instance, and as one non-limiting type of signaling type, a Beacon request and report exchange may be completed between Current AP MLD 604 and Non-AP MLD 602 in order for Current AP MLD 604 to determine capabilities of Non-AP MLD 602 and set of target AP MLDs that are visible to the Non-AP MLD, for purposes of determining candidate target AP MLD(s) to roam to.

In response to receiving an indication of capabilities of Non-AP MLD 602, Current AP MLD 604 determines, at 808, candidate target AP MLD(s) in the same manner as described above with reference to FIGS. 5-7.

Signaling exchanges 810 may be the same as signaling exchanges 620 of FIG. 6 for performing static context transfer and/or static context negotiation, link setup for one or more links and/or resource reservation on candidate target AP MLDs as described above.

Signaling exchange 812 may be similar to signaling exchange 622 of FIG. 6. For instance, using a Roaming Notification exchange (or alternatively Link Reconfiguration request and response frames as described above with reference to FIG. 6 or new set of management frames), Current AP MLD 604 may send the list of candidate target AP MLD(s) and associated RAD(s) to Non-AP MLD 602. The list, as described above, may be in the preference order of candidate Target AP MLDs, an indication of set of one or more static context that were transferred to the candidate target AP MLDs, an indication of one or more context that were negotiated with the candidate target AP MLDs, an indication of resources reserved at the candidate target AP MLDs, or RAD(s) as described above.

Once signaling exchange 812 is complete, roaming preparation phase may be considered complete.

In response, Non-AP MLD 602 may select, at step 814, a target AP MLD from the list of candidate target AP MLDs in the same manner as described above with reference to FIGS. 5-7. Once step 814 is performed, roaming execution may be triggered when Non-AP MLD 602 sends signaling exchange 816 to Current AP MLD 604.

Signaling exchange 816 may be the same as signaling exchange 626 of FIG. 6. For example, Non-AP MLD 602 may send a Roaming execution request (e.g. an Add Link Request, a Link reconfiguration request or a link reconfiguration notify) to Current AP MLD 604 to request roaming to the selected target AP MLD along with one or more requested links to be established with target AP MLD (e.g. in cases when links to be setup are different than the links that are setup in the roaming preparation phase.

After Current AP MLD 604 receives a Roaming execution request (e.g., an Add Link Request, a Link Reconfiguration request, a link reconfiguration notify etc.), signaling exchanges 818 may take place between Current AP MLD 604 and target AP MLD (e.g., one of Target AP MLDs 606). This exchange may be performed according to any known or to be developed signaling procedure whereby, Current AP MLD 604 confirms the roaming with selected target AP MLD and exchanges dynamic context (e.g., SN and/or PN and/or block ack contest) with selected target AP MLD. The set of links requested may be same as the links setup in the roaming preparation phase with the target AP MLD. In such a case, the Non-AP MLD may omit including set of links again and indicate to perform roaming with the links that are already setup in the roaming preparation phase.

After signaling exchanges 818 (or alternatively in parallel with signaling exchanges 818), signaling exchange 820 may occur between Current AP MLD 604 and Non-AP MLD 602. Current AP MLD 604 may send a Roaming execution response (e.g., Add Link response, Link reconfiguration response, etc.) to Non-AP MLD 602 to confirm that roaming execution and dynamic context transfer as part of that process is complete.

During the dynamic context transfer and/or negotiation of dynamic context, in parallel, the target AP MLD may initiate a DS (distribution system) mapping change to switch the data path for the Non-AP MLD from the current AP MLD to the target AP MLD. The DS mapping change may be completed via signaling exchange 822 between target AP MLD 606 and DS 608, as described above.

Once DS mapping update has been initiated for data path switch for Non-AP MLD 602 is complete, using signaling exchange 824, Current AP MLD 604 may cancel resources reserved on other candidate target AP MLD(s) (e.g., the ones not selected as target AP MLD by Non-AP MLD 602). Alternatively, the resource reservation (and links setup) on other candidate target AP MLDs can expire automatically.

Thereafter, using signaling exchange 826, Current AP MLD 604 may send a Roaming Execution response (e.g., delete Link response, Link Reconfiguration response, Link reconfiguration notify, etc.) to Non-AP MLD 602 to delete current link between Non-AP MLD 602 and Current AP MLD 604. In one example, signaling exchange 826 may occur prior to or simultaneous with signaling exchange 824.

In another embodiment, the explicit link deletion step may be skipped and link deletion may be done implicitly based on a timer value specified by the current AP MLD in the roaming execution response. At this point, UL/DL transmissions may be performed between Non-AP MLD 602, selected Target AP MLD from among Target AP MLDs 606, and DS 608 using signaling exchanges 828.

In one example, roaming cancelation may be performed in a similar manner as described above with reference to FIG. 6.

Example embodiments described above with reference to FIGS. 5-8 are directed to multi-phased roaming procedures (either client initiated as described with reference to FIGS. 5 and 6 or AP MLD initiated as described with reference to FIGS. 7 and 8). This multi-phased roaming process includes a roaming preparation phase and a roaming execution phase as described.

With reference to FIG. 4, it is mentioned that in some examples, a Non-AP MLD such as Non-AP MLD 602 may not have sufficient time to perform the roaming preparation phase (e.g., due to a sudden drop in RSSI, for example). Accordingly, in such scenarios, static context may be transmitted to a target AP MLD (e.g., AP MLD2 306) by the current AP MLD (e.g., Current AP MLD 604) along with the dynamic context during the roaming execution phase. Furthermore, in some examples, due to insufficient time for performing the roaming preparation phase, Non-AP MLD 602 may not have time to perform tasks such as selecting a desired target AP MLD from a list of candidate Target AP MLDs, negotiate static context, negotiate RADs, etc.

Moreover, in example embodiments described above with reference to FIGS. 5-8, Current AP MLD 604, along with sending static context to Target AP MLDs, also reserves resources on the Target AP MLDs for when Non-AP MLD 602 to use for roaming during the subsequent roaming execution phase. However, example embodiments are not limited thereto.

For instance, in some examples, during roaming preparation phase, Current AP MLD 604 may not reserve resources on target AP MLDs. In this scenario, static context transfer may be performed in the same manner as described above with reference to FIGS. 5-8. If near static contexts change after the roaming preparation phase, then Current AP MLD 604 transfers updated contexts to target AP MLDs (e.g., AP MLD2 306, AP MLD3 308, etc.). Furthermore, a ‘roaming preparation period’ can be provided (signaled) to Non-AP MLD 602, after which the static context information gets auto deleted on target AP MLDs. If no such period is specified, then static context is maintained on target AP MLDs for as long as Non-AP MLD 602 remains associated with the ESS. In some examples, the near static context also gets deleted on a target AP MLD (e.g., AP MLD3 308) if Non-AP MLD 602 roams to a different target AP MLD (e.g., AP MLD2 306) and/or if the next roaming notification from Non-AP MLD 602 or an unsolicited roaming notification from Current AP MLD 604 to Non-AP MLD 602 does not include that target AP MLD (e.g., AP MLD3 308).

The process of roaming preparation phase wherein resources are not reserved on candidate target AP MLDs may be carried out in the same manner as described with reference to FIG. 6 and/or FIG. 8, except that signaling exchanges 620 (or signaling exchanges 810 in case of FIG. 8) does not include any resource reservation on Target AP MLDs 606. Furthermore, the subsequent roaming execution phase (for scenarios in which resource reservation is not carried out in the roaming preparation phase) may be as follows.

Roaming execution may be triggered via signaling exchange 626 (or signaling exchange 816 in case of FIG. 8). This signaling exchange (e.g., Roaming Add Link request, Link Reconfiguration Request or another management frame) may include client specified quality of roaming. In one example, quality of roaming indicates what resources must be reserved on the target AP(s). Non-AP MLD 602 may indicate the desired roaming quality according to the following two non-limiting examples. However, the present disclosure is not limited thereto and any other known or to be developed procedure for Non-AP MLD 602 to indicate desired roaming quality(es) to Current AP MLD 604 may be utilized.

In one example, roaming quality may be indicated via an orderable roaming quality tier. In this example, Non-AP MLD 602 indicates roaming quality tiers in Roaming Add Link request in preference order starting with the highest quality tier. Each subsequent quality tier is a subset of the previous quality tier. For example, roaming quality tiers maybe defined in orderable tiers as below:
Tier 1: Reserve resources for all SCS+QOS IE and all TWT agreements;
Tier 2: Reserve resources for all SCS+QOS IE, all iTWT and all rTWT agreements;
Tier 3: Reserve resources for all SCS+QOS IE and all rTWT agreements;
Tier 4: Reserve resources for all SCS+QOS IE;
Tier 5: Reserve no resources.

In another example, Non-AP MLD 602 may utilize a features bitmap for indicating roaming quality tiers. A bitmap may be similar to example bitmap described above, wherein Non-AP MLD 602 explicitly indicates which feature resources are to be reserved at each quality tier. For example, roaming quality tiers could be defined using features bitmap as below:
Tier 1: Features bitmap indicating all SCS+QOS IE and all TWT agreements;
Tier 2: Features bitmap indicating all SCS+QOS IE;
Tier 3: Features bitmap indicating all SCS+QOS IE, all iTWT and all rTWT agreements;
Tier 4: Features bitmap indicating all SCS+QOS IE, and all rTWT agreements;
Tier 5: Features bitmap indicating all rTWT agreements;
Tier 6 Features bitmap indicating no features.

Accordingly, Non-AP MLD 602 specifies preference order for roaming tiers in Roaming Add Link request for the target AP. In another example, Non-AP MLD 602 may specify roaming tiers across multiple APs of a target AP MLD or multiple APs of two different target AP MLDs. For example, Non-AP MLD 602 can specify roaming quality tiers across APs of AP MLD2 306 as in example below:

AP3 Tier 1>AP3 Tier 2>AP4 Tier 1>AP4 Tier 2 . . . >AP1 Tier N (where N is equal to the number of tiers (e.g., 6 tiers in the example above).

Upon receiving roaming preferences of Non-AP MLD 602, Current AP MLD 604 may attempt to reserve resources based on desired roaming quality tier preference order on the selected target AP MLD. This resource reservation may be performed simultaneously with dynamic context transfer via signaling exchange 628 (or signaling exchanges 818 in case of FIG. 8).

In some examples, whenever the first roaming tier succeeds in terms of resource reservation on a selected target AP MLD, Current AP MLD 604 can perform an immediate roaming execution or a future roaming execution.

When immediate roaming execution is performed, Current AP MLD 604 transfers dynamic context to the selected target AP MLD. Target AP MLD may keep the static context based on roaming tier for which resources have been reserved. Current AP MLD 604 may send Roaming Add Link response (signaling exchange 632 of FIG. 6 or signaling exchange 824 in case of FIG. 8) to Non-AP MLD 602 indicating the roaming tier for which roaming got executed with resources reserved on the target AP MLD.

When a future roaming execution is performed, Current AP MLD 604 may send a Roaming Add Link Response (signaling exchange 632 of FIG. 6 or signaling exchange 824 in case of FIG. 8) to Non-AP MLD 602 with roaming tier for which resources have been reserved. Current AP MLD 604 may also provide a ‘roaming allowed duration’ timeout. Non-AP MLD 602 may then send a second Roaming Add Link request to Current AP MLD 604 within that timeout. Current AP MLD 604 then transfers dynamic context to the target AP and sends Roaming Add Link response to Non-AP MLD 602. If the second Roaming Add Link request is not received from Current AP MLD 604 during the ‘roaming allowed duration’, then resource reservation on target AP MLD is removed, and roaming is not performed.

In both scenarios of immediate or future roaming execution, after dynamic context is transferred, target AP MLD returns group keys for added links and AID assigned to a STA of Non-AP MLD 602. Then, Current AP MLD 604 sends group keys and AID to Non-AP MLD 602 in the Roaming Add Link Response. If the accepted roaming quality tier did not reserve all desired resources, Non-AP MLD 602 can attempt to create those agreements with the target AP MLD at a later point in time.

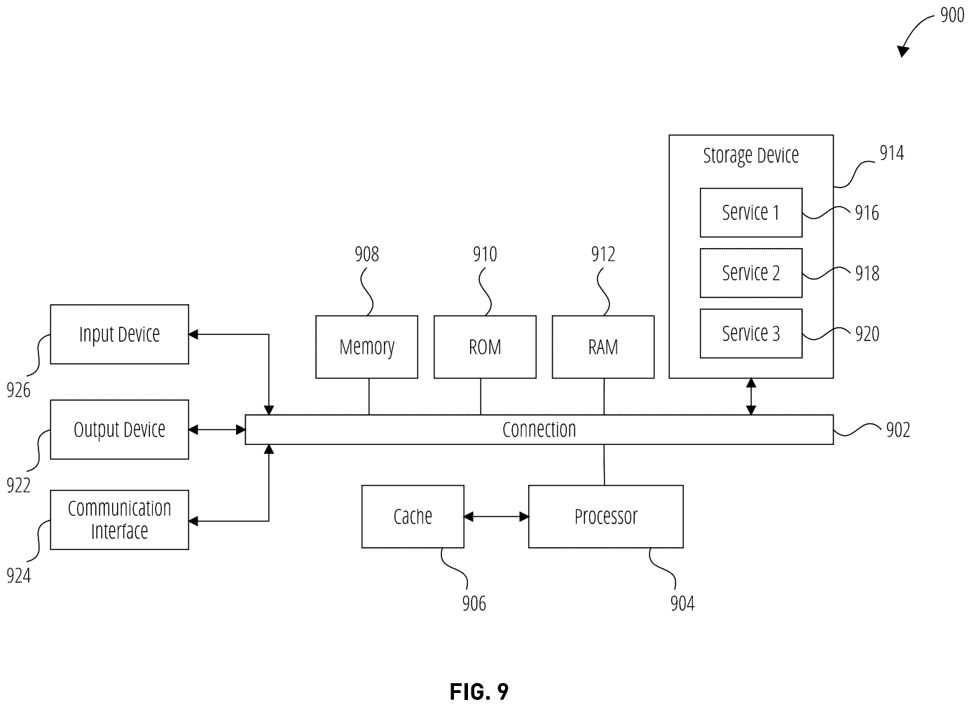

FIG. 9 shows an example of a computing system according to some aspects of the present disclosure. Computing system 900 can be for example any computing device making up any of the devices described above with reference to FIGS. 1-7 (e.g., Non-AP MLD 310, AP MLD1 304, AP MLD2 306, AP MLD3 308, etc.). Components of Computing system 900 system are in communication with each other using connection 902. Connection 902 can be a physical connection via a bus, or a direct connection into processor 904, such as in a chipset architecture. Connection 902 can also be a virtual connection, networked connection, or logical connection.

In some embodiments, computing system 900 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 900 includes at least one processing unit (CPU) or processor such as processor 904 and connection 902 that couples various system components including system memory 908, a read-only memory (ROM) such as ROM 910, and a random-access memory (RAM) such as RAM 912 to processor 904. Computing system 900 can include a cache 906 of system memory 908 connected directly with, in close proximity to, or integrated as part of processor 904.

Processor 904 can include any general-purpose processor and a hardware service or software service, such as service 1 916, service 2 918, and service 3 920 stored in storage device 914, configured to control processor 904 as well as a special-purpose processor where software instructions are incorporated into the actual processor design. Processor 904 may essentially be a completely self-contained Computing system, containing multiple cores or processors, a bus, memory controller, cache, etc. A multi-core processor may be symmetric or asymmetric.

To enable user interaction, Computing system 900 includes an input device 926, which can represent any number of input mechanisms, such as a microphone for speech, a touch-sensitive screen for gesture or graphical input, keyboard, mouse, motion input, speech, etc. Computing system 900 can also include output device 922, which can be one or more of a number of output mechanisms known to those of skill in the art. In some instances, multimodal systems can enable a user to provide multiple types of input/output to communicate with Computing system 900. Computing system 900 can include communication interface 924, which can generally govern and manage the user input and system output. There is no restriction on operating on any particular hardware arrangement, and therefore the basic features here may easily be substituted for improved hardware or firmware arrangements as they are developed.

Storage device 914 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 914 can include software services, servers, services, etc., that when the code that defines such software is executed by the processor 904, it causes the system to perform a function. In some embodiments, a hardware service that performs a particular function can include the software component stored in a computer-readable medium in connection with the necessary hardware components, such as processor 904, connection 902, output device 922, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method comprising:
initiating a roaming procedure for a Non-Access Point Multi-Link Device (Non-AP MLD) to roam from a current Access Point Multi-Link Device (current AP MLD) onto a target AP MLD;
determining whether a multi-phased roaming procedure for the Non-AP MLD to roam to the target AP MLD is possible;
performing the multi-phased roaming procedure when the multi-phased roaming procedure is possible; and
performing a single-phased roaming procedure when the multi-phased roaming procedure is not possible.

2. The method of claim 1, wherein the multi-phased roaming procedure includes a roaming preparation phase procedure and a roaming execution phase procedure.

3. The method of claim 2, wherein the roaming preparation phase procedure includes one or more of:
transferring a first one or more static context associated with the Non-AP MLD to one or more candidate target AP MLDs, wherein the target AP MLD is selected from among the one or more candidate target AP MLDs;
negotiating a second one or more static context associated with the Non-AP MLD with one or more candidate target AP MLDs;
setting up one or more first links for the Non-AP MLD with one or more candidate target AP MLDs, and
reserving one or more resources on the one or more candidate target AP MLDs for possible roaming of the Non-AP MLD thereon.

4. The method of claim 3, wherein,
the one or more candidate target AP MLDs, the target AP MLD and the current AP MLD are associated with a same seamless mobility domain; and
the roaming preparation phase procedure is initiated by the Non-AP MLD or the current AP MLD.

5. The method of claim 3, wherein the first one or more static context and the second one or more static context include at least one of:
block acknowledgement agreements setup for the Non-AP MLD;
stream classification service (SCS) streams setup for the Non-AP MLD;
mirrored stream classification service (MSCS) streams setup for the Non-AP MLD;
target wake time (TWT) agreements setup for the Non-AP MLD;
TID-to-link mapping (TTLM) agreements setup for the Non-AP MLD;
security association context associated with the Non-AP MLD; and
capabilities of the Non-AP MLD.

6. The method of claim 3, further comprises:
providing a roaming allowed duration (RAD) to the Non-AP MLD that indicates a window of time during for the Non-AP MLD to complete the roaming execution phase procedure.

7. The method of claim 3, further comprising:
sending a roaming preparation request to the current AP MLD to initiate the roaming preparation phase procedure, and
receiving a roaming preparation response from the current AP MLD after the roaming preparation phase procedure is performed.

8. The method of claim 7, wherein,
the roaming preparation request is one of a link reconfiguration request frame, a link reconfiguration notify frame, or another management frame; and
the roaming preparation response is one of a link reconfiguration response frame, a link reconfiguration notify frame or another management frame.

9. The method of claim 3, wherein the roaming execution phase procedure include one or more of:
transferring a first one or more dynamic context associated with the Non-AP MLD to the target AP MLD;
negotiating a second one or more dynamic context associated with the Non-AP MLD with the target AP MLD;
setting up one or more second links for the Non-AP MLD with the target AP MLD; and
changing a distribution system mapping to switch a data path for the Non-AP MLD from the current AP MLD to the target AP MLD.

10. The method of claim 9, wherein the first one or more dynamic context and the second one or more dynamic context includes at least one of a sequence numbers (SN); a packet numbers (PN);
block acknowledgement agreements, block acknowledgement parameters and related context; or
duplicate receiver caches corresponding to data associated with the Non-AP MLD.

11. The method of claim 9, further comprising:
sending, by the Non-AP MLD, a roaming execution request to the current AP MLD to initiate the roaming execution phase procedure, and
receiving a roaming execution response from the current AP MLD after the roaming execution phase procedure is performed.

12. The method of claim 11, wherein,
the roaming execution request is a link reconfiguration request frame or another management frame; and
the roaming execution response is a link reconfiguration response frame or another management frame.

13. The method of claim 1, wherein the multi-phased roaming procedure for the Non-AP MLD to roam to the target AP MLD is not possible when an unexpected network performance degradation is detected for the Non-AP MLD.

14. The method of claim 1, wherein the single-phased roaming procedure includes a roaming execution phase procedure that includes on or more of:
transferring at least one of one or more static context, or one or more dynamic context associated with the Non-AP MLD to the target AP MLD;
negotiating at least one of the one or more static context, or the one or more dynamic context associated with the Non-AP MLD;
setting up one or more links for the Non-AP MLD with the target AP MLD; and
changing a distribution system mapping to switch a data path for the Non-AP MLD from the current AP MLD to the target AP MLD.

15. The method of claim 1, wherein initiating the roaming procedure comprises:
detecting one or more roaming factors that trigger the Non-AP MLD to initiate the roaming procedure.

16. A device comprising:
one or more memories having computer-readable instructions stored therein; and
one or more processors configured to execute the computer-readable instructions to:
initiate a roaming procedure for the device to roam from a current Access Point Multi-Link Device (AP MLD) onto a target AP MLD;
determine whether a multi-phased roaming procedure for the device to roam to the target AP MLD is possible;
perform the multi-phased roaming procedure when the multi-phased roaming procedure is possible; and
perform a single-phased roaming procedure when the multi-phased roaming procedure is not possible.

17. The device of claim 16, wherein the device is a Non-Access Point Multi-Link Device (Non-AP MLD).

18. The device of claim 16, wherein the multi-phased roaming procedure includes a roaming preparation phase procedure and a roaming execution phase procedure.

19. The device of claim 18, wherein the roaming preparation phase procedure includes at least one of:
exchanging one or more static context associated with the device to one or more candidate target AP MLDs, wherein the target AP MLD is selected from among the one or more candidate target AP MLDs; or
reserving one or more resources on the one or more candidate target AP MLDs for possible roaming of the device thereon.

20. The device of claim 18, wherein the roaming execution phase procedure includes sending one or more dynamic context associated with the device to the target AP MLD.
